(19) United States
(12) Patent Application Publication
(10) Pub. No.: US 2025/0075627 A1
(43) Pub. Date: Mar. 6, 2025

(54) SYSTEMS AND METHODS OF ACTIVE CLEARANCE CONTROL IN A GAS TURBINE ENGINE

(71) Applicant: General Electric Company, Schenectady, NY (US)

(72) Inventors: Donald Ira Goepper, West Chester, OH (US); Timothy Leo Schelfaut, Liberty Township, OH (US); Taehong Kim, Liberty Township, OH (US)

(21) Appl. No.: 18/461,088

(22) Filed: Sep. 5, 2023

(51) Int. Cl. F01D 11/22

(52) U.S. Cl. CPC F01D 11/22; F05D 2220/323; F05D 2240/55; F05D 2270/335; F05D 2270/62

(57) ABSTRACT

A method of operating a gas turbine engine is provided. The method includes receiving sensor data from one or more sensors. The method further includes receiving additional data associated with an engine event. The method further includes generating a current clearance based on at least one of the sensor data and the additional data associated with the engine event. The method further includes generating a target clearance based on at least one of the sensor data and the additional data associated with the engine event and comparing the target clearance to the current clearance. The method further includes causing the clearance adjustment system to adjust the clearance based on the comparison between the target clearance and the actual clearance by actuating the piezoelectric actuator.

### FIELD

The disclosure relates generally to a gas turbine engine and, more particularly, to methods of operating a fast response active clearance system.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section. Fuel mixes with the compressed air and burns within the combustion section, thereby creating combustion gases. The combustion gases flow from the combustion section through a hot gas path defined within the turbine section and then exit the turbine section via the exhaust section.

In general, it is desirable for a gas turbine engine to maintain clearance between the tip of a blade in the gas turbine engine and the stationary parts of the gas turbine engine (e.g., the gas turbine engine casing, stator, etc.). During operation, the gas turbine engine is exposed to thermal (e.g., hot and cold air pumped into the gas turbine engine, etc.) and mechanical loads (e.g., centrifugal force on the blades on the gas turbine engine, etc.), which can expand and contract the gas turbine engine casing and rotor. The expansion and contraction of the gas turbine engine casing can change the clearance between the blade tip and the stationary parts of the gas turbine engine. There is a continuing need to control the clearance between the blade tip and the engine casing that fluctuates during normal operation for a gas turbine engine to avoid damage to the gas turbine engine (e.g., wear, breakage, etc. due to unintentional rub). Additionally, there is a desire to maintain a tight clearance between the blade tip and the engine casing during various different operating scenarios in order to increase performance of the gas turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a cross-sectional view of a turbine section of a gas turbine engine in accordance with an embodiment of the present disclosure.

FIG. 3 is a cross-sectional view of a turbine section of gas turbine engine in accordance with another embodiment of the present disclosure.

FIG. 4 illustrates a gas turbine engine having an engine controller configured to implement a clearance control scheme during one or more engine events in accordance with an exemplary aspect of the present disclosure.

FIG. 5 illustrates a gas turbine engine having an engine controller configured to implement a clearance control scheme during a cold clearance zeroing event in accordance with an exemplary aspect of the present disclosure.

FIG. 6 illustrates a gas turbine engine having an engine controller configured to implement a clearance control scheme during a vehicle maneuver in accordance with an exemplary aspect of the present disclosure.

FIG. 7 illustrates a gas turbine engine having an engine controller configured to implement a clearance control scheme during a vehicle maneuver in accordance with an exemplary aspect of the present disclosure.

FIG. 8 illustrates a gas turbine engine having an engine controller configured to implement a clearance control scheme during an engine acceleration event in accordance with an exemplary aspect of the present disclosure.

FIG. 9 illustrates a gas turbine engine having an engine controller configured to implement a clearance control scheme during a stall event in accordance with an exemplary aspect of the present disclosure.

FIG. 10 illustrates a gas turbine engine having an engine controller configured to implement a clearance control scheme during a bowed rotor start event in accordance with an exemplary aspect of the present disclosure.

FIG. 11 illustrates a gas turbine engine having an engine controller configured to implement a clearance control scheme during a non-synchronous vibration event in accordance with an exemplary aspect of the present disclosure.

FIG. 12 illustrates a gas turbine engine having an engine controller configured to implement a clearance control scheme during an Alford whirl induced non-synchronous vibration event in accordance with an exemplary aspect of the present disclosure.

FIG. 13 illustrates a gas turbine engine having an engine controller configured to implement a clearance control scheme during high rotor thrust event in accordance with an exemplary aspect of the present disclosure.

FIG. 14 illustrates a flow diagram of one embodiment of a method of operating a gas turbine engine is illustrated in accordance with embodiments of the present disclose.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. “HP” denotes high pressure and “LP” denotes low pressure.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

A conventional Active Clearance Control system (“ACC system”) utilizes cooling air from a fan or compressor to control the clearance between the blade tip and a stationary component by thermally expanding/contracting the stationary component. However, the conventional ACC system is limited in response time for modulating clearance due to the time delay for using a thermal response.

The ACC system disclosed herein uses piezoelectric actuator(s) that provide fast response clearance control without the thermal delay seen in the conventional ACC system. Additionally, the ACC system disclosed herein maintains desired clearances between the blade tip and shroud segments without additional margin for various operating conditions, which will lead to performance improvement and provide better exhaust gas temperature (EGT) control capability. In certain examples, piezoelectric material generates linear displacement when an electric field is applied. The linear displacement can have a force, and examples disclosed herein apply the linear force of the piezoelectric material for the ACC system to achieve fast response clearance control.

The ACC system disclosed herein may be operated according to various control schemes that would otherwise not be possible with the use of a conventional ACC system. In a first example control scheme, when the gas turbine engine is assembled, the cold clearance parameter may be reduced or eliminated by calibrating the piezoelectric actuators (e.g., touching the stators to the rotor blades), which allows for a more accurate determination of current clearance by the engine controller. In other example embodiments, the engine controller may receive vehicle data, such as acceleration loads, current yaw, pitch, and/or roll from the aircraft (i.e., stick position), or throttle position (i.e., power demand). In such embodiments, based on the vehicle data, the engine controller may determine the current mechanical distortion or thermal distortion of one or more components in the gas turbine, and the engine controller may instruct the ACC system to adjust the clearance according to the determined mechanical distortion. Alternatively, or additionally, based on the vehicle data, the engine controller may determine whether the engine is accelerating and may adjust the target clearance according to the magnitude of the acceleration. In yet still further implementations of the control scheme, the engine controller may receive data from a sensor indicative of a stall condition, and the engine controller may instruct the ACC system to adjust the clearance in order to clear the stall condition. Additionally, in various embodiments, the engine controller may receive data indicative of an engine vibration caused by a bowed rotor, and the engine controller may instruct the ACC system to adjust the clearance in order to account for the bowed rotor and resulting dynamic clearance closures caused by the bowed rotor. Furthermore, in some embodiments, the engine controller may receive data indicative of an engine vibration caused by non-synchronous vibration (“NSV”), and the engine controller may instruct the ACC system to adjust the clearance in order to clear or eliminate the NSV. In other embodiments, the engine controller may receive data indicative of a rotor thrust measurement that nears or exceeds a thrust bearing maximum threshold, and the engine controller may instruct the ACC system to adjust the clearance in order to reduce the rotor thrust.

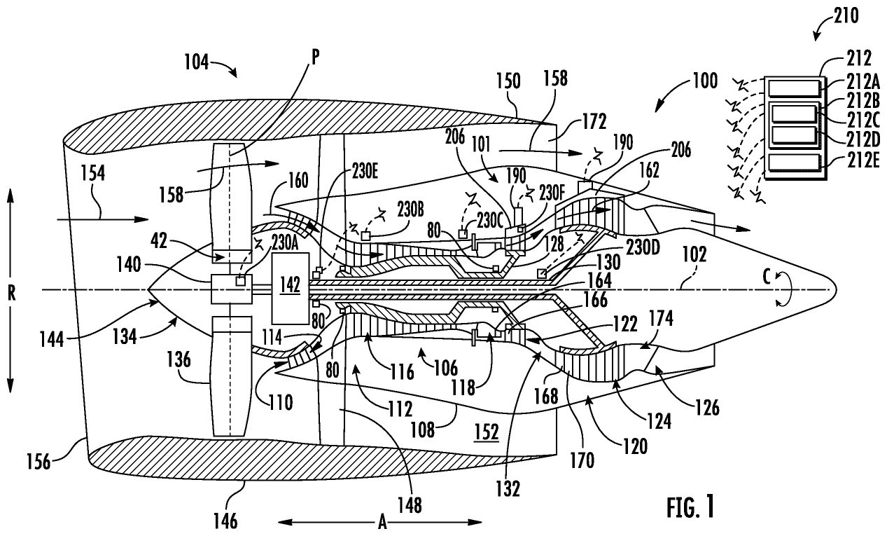

Referring now to the drawings, wherein identical numerals indicate the same elements throughout the figures, FIG. 1 provides a schematic cross-sectional view of a gas turbine engine 100 according to an example embodiment of the present disclosure. For the depicted embodiment of FIG. 1, the gas turbine engine 100 is an aeronautical, high-bypass turbofan jet engine configured to be mounted to an aircraft, e.g., in an under-wing configuration. As shown, the gas turbine engine 100 defines an axial direction A, a radial direction R, and a circumferential direction C. The axial direction A extends parallel to or coaxial with a longitudinal centerline 102 defined by the gas turbine engine 100.

The gas turbine engine 100 includes a fan section 104 and a core turbine engine 106 disposed downstream of the fan section 104. The core turbine engine 106 includes an engine cowl 108 that defines an annular inlet 110. The engine cowl 108 encases, in a serial flow relationship, a compressor section 112 including a first, booster or LP compressor 114 and a second, HP compressor 116; a combustion section 118; a turbine section 120 including a first, HP turbine 122 and a second, LP turbine 124; and an exhaust section 126. An HP shaft 128 drivingly connects the HP turbine 122 to the HP compressor 116. An LP shaft 130 drivingly connects the LP turbine 124 to the LP compressor 114. The compressor section 112, combustion section 118, turbine section 120, and exhaust section 126 together define a core air flowpath 132 through the core turbine engine 106.

The fan section 104 includes a fan 134 having a plurality of fan blades 136 coupled to a disk 138 in a circumferentially spaced apart manner. As depicted, the fan blades 136 extend outward from the disk 138 generally along the radial direction R. Each fan blade 136 is rotatable relative to the disk 138 about a pitch axis P by virtue of the fan blades 136 being operatively coupled to a suitable actuation member 140 configured to collectively vary the pitch of the fan blades 136, e.g., in unison. The fan blades 136, disk 138, and actuation member 140 are together rotatable about the longitudinal centerline 102 by the LP shaft 130 across a power gearbox 142. The power gearbox 142 includes a plurality of gears for stepping down the rotational speed of the LP shaft 130 to affect a more efficient rotational fan speed. In other embodiments, the fan blades 136, disk 138, and actuation member 140 can be directly connected to the LP shaft 130, e.g., in a direct-drive configuration. Further, in other embodiments, the fan blades 136 of the fan 134 can be fixed-pitch fan blades.

In order to support such rotary components, the gas turbine engine 100 includes a plurality of thrust bearings 80 attached to various static structural components within the gas turbine engine 100. Specifically, for the embodiment depicted in FIG. 1, the thrust bearings 80 support and facilitate rotation of, e.g., the LP shaft 130 and the HP shaft 128. Although the thrust bearings 80 are described and illustrated as being located generally at forward and aft ends of the respective LP shaft 130 and HP shaft 128, the thrust bearings 80 may additionally, or alternatively, be located at any desired location along the LP shaft 130 and HP shaft 128 including, but not limited to, central or mid-span regions of the shafts 130, 128, or other locations.

Referring still to FIG. 1, the disk 138 is covered by a rotatable spinner 144 aerodynamically contoured to promote an airflow through the plurality of fan blades 136. Additionally, the fan section 104 includes an annular fan casing or outer nacelle 146 that circumferentially surrounds the fan 134 and/or at least a portion of the core turbine engine 106. The nacelle 146 is supported relative to the core turbine engine 106 by a plurality of circumferentially-spaced outlet guide vanes 148. A downstream section 150 of the nacelle 146 extends over an outer portion of the core turbine engine 106 so as to define a bypass airflow passage 152 therebetween.

During operation of the gas turbine engine 100, a volume of air 154 enters the gas turbine engine 100 through an associated inlet 156 of the nacelle 146 and/or fan section 104. As the volume of air 154 passes across the fan blades 136, a first portion of the air 154, as indicated by arrows 158, is directed or routed into the bypass airflow passage 152 and a second portion of the air 154, as indicated by arrow 160, is directed or routed into the LP compressor 114. The pressure of the second portion of air 160 is increased as it is routed through the LP compressor 114 and the HP compressor 116. The compressed second portion of air 160 is then discharged into the combustion section 118.

The compressed second portion of air 160 from the compressor section 112 mixes with fuel and is burned within a combustor of the combustion section 118 to provide combustion gases 162. The combustion gases 162 are routed from the combustion section 118 along a hot gas path 174 of the core air flowpath 132 through the HP turbine 122 where a portion of thermal and/or kinetic energy from the combustion gases 162 is extracted via sequential stages of HP turbine stator vanes 164 and HP turbine blades 166. The HP turbine blades 166 are mechanically coupled to the HP shaft 128. Thus, when the HP turbine blades 166 extract energy from the combustion gases 162, the HP shaft 128 rotates, thereby supporting operation of the HP compressor 116. The combustion gases 162 are routed through the LP turbine 124 where a second portion of thermal and kinetic energy is extracted from the combustion gases 162 via sequential stages of LP turbine stator vanes 168 and LP turbine blades 170. The LP turbine blades 170 are coupled to the LP shaft 130. Thus, when the LP turbine blades 170 extract energy from the combustion gases 162, the LP shaft 130 rotates, thereby supporting operation of the LP compressor 114 and the fan 134.

The combustion gases 162 are subsequently routed through the exhaust section 126 of the core turbine engine 106 to provide propulsive thrust. Simultaneously, the pressure of the first portion of air 158 is substantially increased as the first portion of air 158 is routed through the bypass airflow passage 152 before it is exhausted from a fan nozzle exhaust section 172 of the gas turbine engine 100, also providing propulsive thrust. The HP turbine 122, the LP turbine 124, and the exhaust section 126 at least partially define the hot gas path 174 for routing the combustion gases 162 through the core turbine engine 106.

As further shown in FIG. 1, the gas turbine engine 100 includes a clearance adjustment system, which in this embodiment is an active clearance control (ACC) system 101. Generally, the ACC system 101 is configured to dynamically control the blade tip clearances between a rotating component, such as a turbine blade, and a stationary component, such as a shroud. For this embodiment, the ACC system 101 includes a piezoelectric actuator 190 attached to a shroud segment 206. As discussed below in detail, the piezoelectric actuator 190 may be in operable communication with an engine controller 210, which may send control signals to actuate the piezoelectric actuator 190, thereby moving the shroud segment 206 in any of the radial, axial, or circumferential directions.

Referring still to FIG. 1, the exemplary ACC system 101 is operably connected to an engine controller 210. The controller 210 can be, for example, an Electronic Engine Controller (EEC), an Electronic Control Unit (ECU), or a Full Authority Digital Engine Control (FADEC) system. The engine controller 210 includes various components for performing various operations and functions, such as controlling clearances.

The engine controller 210 may be configured to receive data indicative of various operating conditions and parameters of the gas turbine engine 100 during operation of the gas turbine engine 100. For example, the gas turbine engine 100 includes one or more sensors 230 configured to sense data indicative of various operating conditions and parameters of the gas turbine engine 100, such as rotational speeds, temperatures, pressures, vibrations, etc. More specifically, however, for the exemplary embodiment depicted in FIG. 1, the one or more sensors 230 includes a first sensor 230A configured to sense data indicative of one or more parameters of the fan section 104 (e.g., rotational speed, acceleration, torque on the rotor shaft driving the fan 134, etc.); a second sensor 230B configured to sense data indicative of the compressors (such as a pressure or a temperature within the HP compressor 116, and/or a pressure or temperature within the LP compressor 114 etc.); a third sensor 230C configured to sense data indicative of one or combustion section parameters (such as a temperature within the combustion section 118, a fuel flow to the combustion section 118, one or more pressures within or around the combustion section 118, etc.), one or more high pressure turbine parameters (such as turbine inlet temperature, a rotational speed of the HP turbine 122, etc.), or both; a fourth sensor 230D operable to sense data indicative of one or more parameters of the low pressure system (such as a rotational speed of the LP shaft 130); a fifth sensor 230E configured to sense data indicative of one or more parameters associated with the thrust bearings 80, such as but not limited to rotor thrust, bearing vibration (For example, non-synchronous vibration and/or Alford whirl induced non-synchronous vibration); and a sixth sensor 230F configured to sense data associated with the shroud segments and/or the rotor blades, such as indicative of a blade tip clearance between rotor blades and shroud segments, or such as data indicative of a contact force when the shroud segments contact the blade tips of the rotor blades, or other data.

In some embodiments, the engine controller 210 may be operable to receive optical data from one or more optical sensors. For example, the system may include one or more light probes that are configured to monitor the compressor blades for positional movement (such as flutter or other aeromechanical movement indicative of aerodynamically unstable conditions within a compressor). The one or more optical sensors (e.g. light probes) may then communicate the sensed data to the engine controller 210.

Referring particularly to the operation of the engine controller 210, in at least certain embodiments, the engine controller 210 can include one or more computing device(s) 212. The computing device(s) 212 can include one or more processor(s) 212A and one or more memory device(s) 212B. The one or more processor(s) 212A can include any suitable processing device, such as a microprocessor, microcontroller, integrated circuit, logic device, and/or other suitable processing device. The one or more memory device(s) 212B can include one or more computer-readable media, including, but not limited to, non-transitory computer-readable media, RAM, ROM, hard drives, flash drives, and/or other memory devices.

The one or more memory device(s) 212B can store information accessible by the one or more processor(s) 212A, including computer-readable instructions 212C that can be executed by the one or more processor(s) 212A. The instructions 212C can be any set of instructions that when executed by the one or more processor(s) 212A, cause the one or more processor(s) 212A to perform operations. In some embodiments, the instructions 212C can be executed by the one or more processor(s) 212A to cause the one or more processor(s) 212A to perform operations, such as any of the operations and functions for which the engine controller 210 and/or the computing device(s) 212 are configured, the operations for operating the ACC system 101, as described herein, and/or any other operations or functions of the one or more computing device(s) 212. The instructions 212C can be software written in any suitable programming language or can be implemented in hardware. Additionally, and/or alternatively, the instructions 212C can be executed in logically and/or virtually separate threads on processor(s) 212A.

The computing device(s) 212 can also include a network interface 212E used to communicate, for example, with the other components of the gas turbine engine 100, the aircraft incorporating the gas turbine engine 100, the ACC system 101, etc. For example, in the embodiment depicted, as noted above, the gas turbine engine 100 includes one or more sensors 230 for sensing data indicative of one or more parameters of the gas turbine engine 100 and various accessory systems, and the ACC system 101 includes a piezoelectric actuator 190. The engine controller 210 is operably coupled to these components through, e.g., the network interface 212E, such that the engine controller 210 may receive data indicative of various operating parameters sensed by the one or more sensors 230 during operation, various operating conditions of the components, etc., and further may provide commands to control the piezoelectric actuators 190 of the ACC system 101 and other operating parameters of these systems, e.g., in response to the data sensed by the one or more sensors 230 and other conditions.

The network interface 212E can include any suitable components for interfacing with one or more network(s), including for example, transmitters, receivers, ports, controllers, antennas, and/or other suitable components. For example, in the embodiment shown, the network interface 212E is configured as a wireless communication network wirelessly in communication with these components (as is indicated by the dashed communication lines in FIG. 1).

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Further, it will be appreciated that the gas turbine engine 100 depicted in FIG. 1 is provided by way of example only, and that in other example embodiments, the gas turbine engine 100 may have any other suitable configuration. Additionally, or alternatively, aspects of the present disclosure may be utilized with any other suitable aeronautical gas turbine engine, such as a turboshaft engine, turboprop engine, turbojet engine, hybrid electric engine, three stream engine, un-ducted fan engine, etc. Further, aspects of the present disclosure may further be utilized with any other land-based gas turbine engine, such as a power generation gas turbine engine, or any aeroderivative gas turbine engine, such as a nautical gas turbine engine.

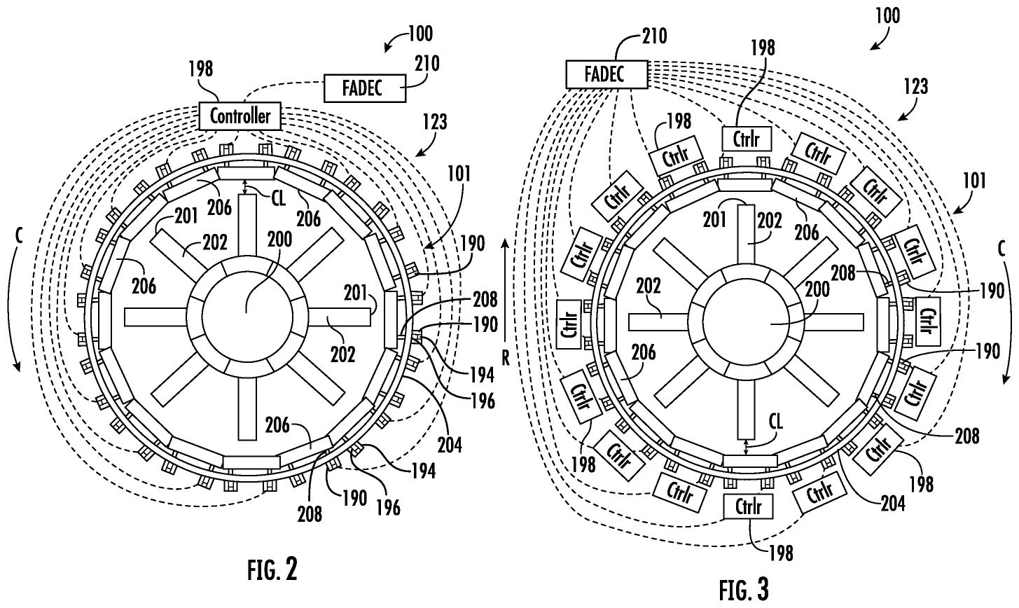

FIGS. 2 and 3 each illustrates a cross-sectional view of a gas turbine engine 100 having a turbine 123 (which may be one of HP turbine 122 or the LP turbine 124 discussed above with reference to FIG. 1) in accordance with embodiments of the present disclosure. As shown, the gas turbine engine 100 may include a rotor 200, a plurality of rotor blades 202 each extending from the rotor 200 to a respective blade tip 201, and a casing 204 surrounding the rotor 200 and the rotor blades 202. A plurality of shroud segments 206 may be circumferentially spaced apart from one another and disposed radially between the casing 204 and the blade tips of the rotor blades 202. The plurality of shroud segments 206 may be independently movable relative to one another and may collectively circumferentially surround the rotor blades 202.

A blade tip clearance CL is defined between the blade tips 201 and the shroud segments 206. It should be noted that the blade tip clearances CL may similarly exist in the LP compressor 114, HP compressor 116, the HP turbine 122,LP turbine 124, and/or the fan 134. Accordingly, the present subject matter disclosed herein is not limited to adjusting blade tip clearances and/or clearance closures in HP turbines; rather, the teachings of the present disclosure may be utilized to adjust blade tip clearances in any suitable section of the gas turbine engine 100. Additionally, the present subject matter disclosed herein (such as the ACC system 101 discussed below) may be incorporated into a labyrinth seal system of a gas turbine engine or any other portion of the gas turbine engine where a clearance is required between a rotating component and a non-rotating component.

Additionally, the gas turbine engine 100 may include the ACC system 101. The ACC system 101 is configured to dynamically control the blade tip clearances CL between the blade tips 201 and the shroud segments 206. For example, the ACC system 101 includes a plurality of piezoelectric actuators 190 each attached to a shroud segment 206 via one or more hangers 208. The piezoelectric actuators 190 may be configured to adjust a position of the hangers 208, which adjusts a position of the shroud segment 206, in any of the axial direction, radial direction, circumferential direction, or any combination of directions.

The piezoelectric actuator 190 may further include a multilayer stack of piezoelectric material 194 disposed within a housing 196. In some examples, the piezoelectric material 194 may include includes quartz, topaz, etc. However, other piezoelectric materials or other materials that generate linear displacement, such as shape memory alloy (SMA) materials, etc., can be additionally and/or alternatively included. In some embodiments, the piezoelectric material 194 may be operatively coupled to one or more electrodes, which may apply an electric charge to the piezoelectric material causing the piezoelectric material 194 to expand or contract, thereby allowing for actuation (i.e., linear displacement) of the shroud segment 206 in any of the axial direction, radial direction, circumferential direction, or any combination of directions.

As shown in FIGS. 2 and 3, the gas turbine engine may include an actuator controller 198 and an engine controller 210 in communication with the actuator controller 198. The actuator controller 198 may be configured similarly to the engine controller 210 described above with reference to FIG. 1 (or may be configured differently). The actuator controller 198 may send electric signals to the piezoelectric material 194 (e.g., at least partially via one or more electrodes) to expand/retract the piezoelectric material and control the linear displacement of the actuator 190, which adjusts a position of the shroud segment 206.

Particularly, as shown in FIG. 2, the gas turbine engine 100 may include a single actuator controller 198 that is configured to modulate (or actuate) all of the actuators 190, such that the single actuator controller is 198 operatively connected to the engine controller 210 and operatively connected to each of the actuators 190. In such embodiments, the single actuator controller 198 may move (or adjust a position) of each of the shroud segments 206 independently of one another by sending electric signals to one or more of the actuators 190.

In other embodiments, as shown in FIG. 3, the gas turbine engine 100 may include a plurality of actuator controllers 198 each operatively connected to the engine controller 210 and operatively connected to at least one actuator 190. In such embodiments, each shroud segment 206 may have a respective actuator controller 198 of the plurality of actuator controllers for modulating the actuators 190 coupled to that specific shroud segment 206. In yet still further embodiments (not shown), the actuator controller 198 and the engine controller 210 may be the same.

In some embodiments, the actuator 190 and the multilayer stack of piezoelectric material 194 may be located outside of the casing 204, which helps to preserve the piezoelectric material 194 in a cold condition without concern of temperature limitations. The location of the actuator 190 and the multilayer stack of piezoelectric material 194 provide a benefit of easy access for maintenance and part replacement. In other embodiments (not shown), the actuator 190 and the multilayer stack of piezoelectric material 194 may be located inside of the casing 204.

It will be appreciated that engine performance is dependent at least in part on the blade tip clearances CL between the turbine blade tips and shrouds. Generally, the tighter the clearance between the blade tips and shrouds (i.e., the more closed the clearances), the more efficient the gas turbine engine can be operated. Thus, minimizing or otherwise reducing the blade tip clearances CL facilitates optimal and/or otherwise improved engine performance and efficiency.

The blade tip clearances CL between turbine blade tips and the surrounding shrouds and turbine casings may be impacted by two main types of loads: power-induced engine loads and flight loads. Power-induced engine loads generally include centrifugal, thermal, internal pressure, and thrust loads. Flight loads generally include inertial, aerodynamic, and gyroscopic loads. Centrifugal and thermal engine loads are responsible for the largest radial axisymmetric variation or deflection in blade tip clearances CL. With regard to centrifugal loads, the blades of turbine engines may mechanically expand depending on their rotational speed. Generally, the faster the rotational speed of the rotor, the greater the mechanical expansion of the turbine blades and thus the further radially outward the blades extend. Conversely, the slower the rotational speed of the rotor, the less mechanical expansion the rotor experiences and the further radially inward the blades extend from the centerline longitudinal axis of the engine. With regard to thermal loads, as the engine heats up or cools down due at least in part to power level changes (i.e., changes in engine speed), the rotor and casings thermally expand and/or contract at differing rates. That is, the rotor is relatively large and heavy, and, thus, the thermal mass of the rotor heats up and cools down at a much slower rate than does the relatively thin and light turbine casings. Thus, the thermal mass of the casings heats up and cools off much faster than the rotor. The time constant (e.g., the time it takes for a component to get to its steady state thermal deflection) may be different for the rotor and the casing. The time constant of the rotor is about 10 minutes whereas the casing is about 1 minute. That is, the casing may heat/cool between about 5-10 times faster.

Accordingly, as an aircraft maneuvers and its engines perform various power level changes, the rotor and casings contract and expand at different rates. As such, the rotor and casings are sometimes not thermally matched. This mismatch leads to changes in the blade tip clearances CL, and, in some cases, the turbomachinery components may come into contact with or rub one another, causing a rub event. For example, a rub event may occur where a blade tip 201 comes into contact with or touches a corresponding shroud segment 206. Rub events may cause poor engine performance and efficiency, may reduce the effective service lives of the rotor blades 202 and shroud segments 206, and may deteriorate the exhaust gas temperature margin of the engine. Thus, ideally, the blade tip clearances CL are set so as to minimize the clearance between the blade tips and the shrouds without the turbomachinery components experiencing rub events. Taking these aspects into consideration, control techniques for setting clearances are provided herein.

It should be appreciated that the ACC system 101, described above with reference to FIGS. 2 and 3, are two examples of a clearance adjustment system in accordance with the present disclosure. In other example embodiments, the clearance adjustment system can have other suitable configurations. The present clearance control schemes described below should not be limited to any particular ACC system configuration unless specifically recited in the claims.

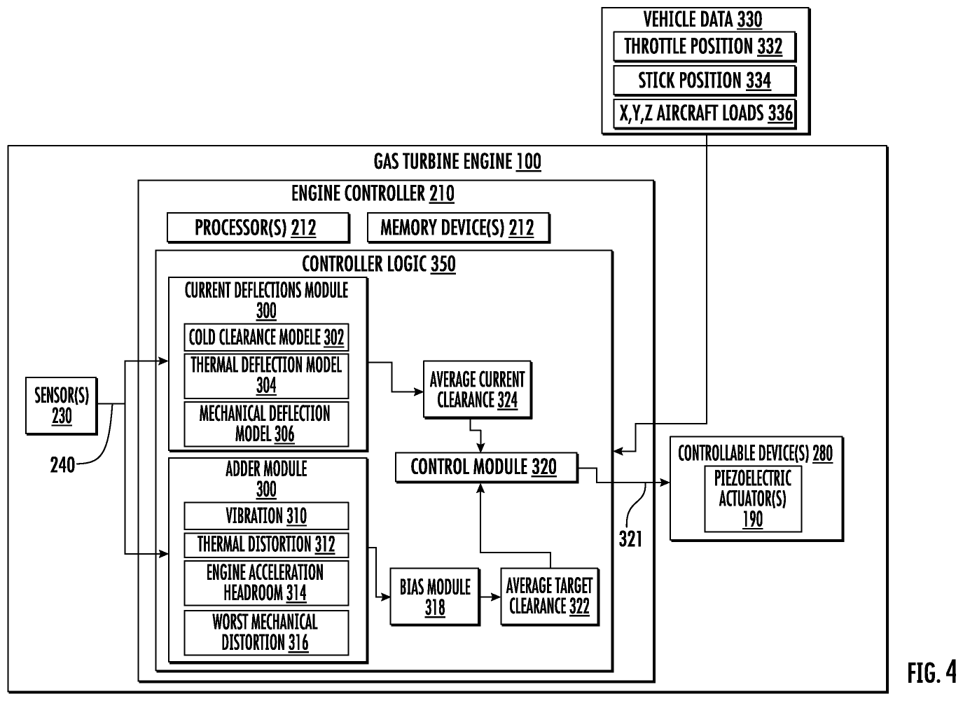

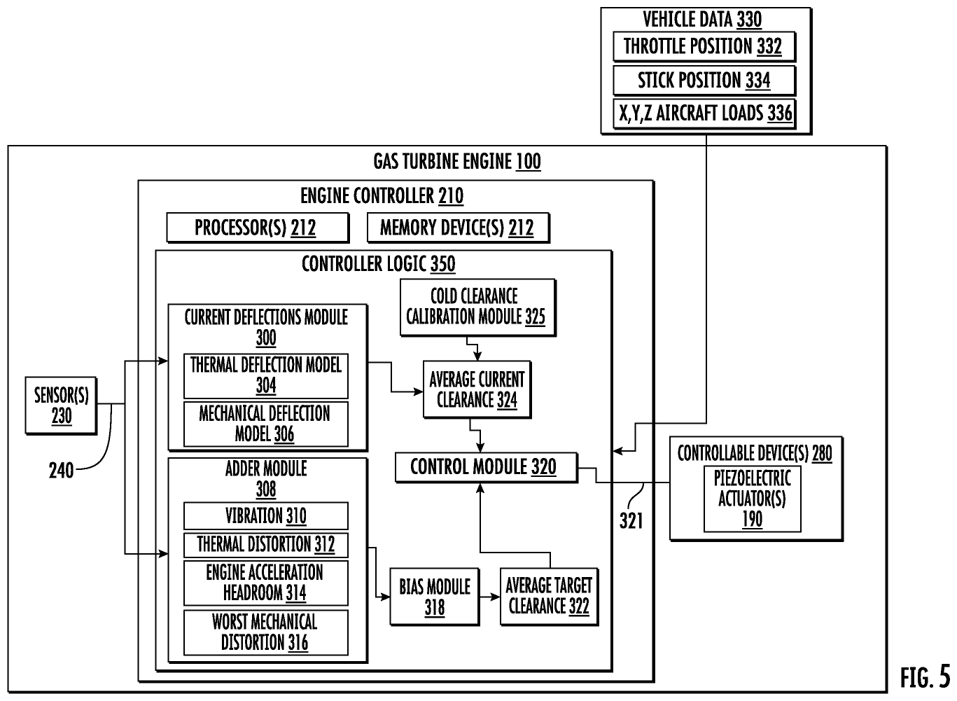

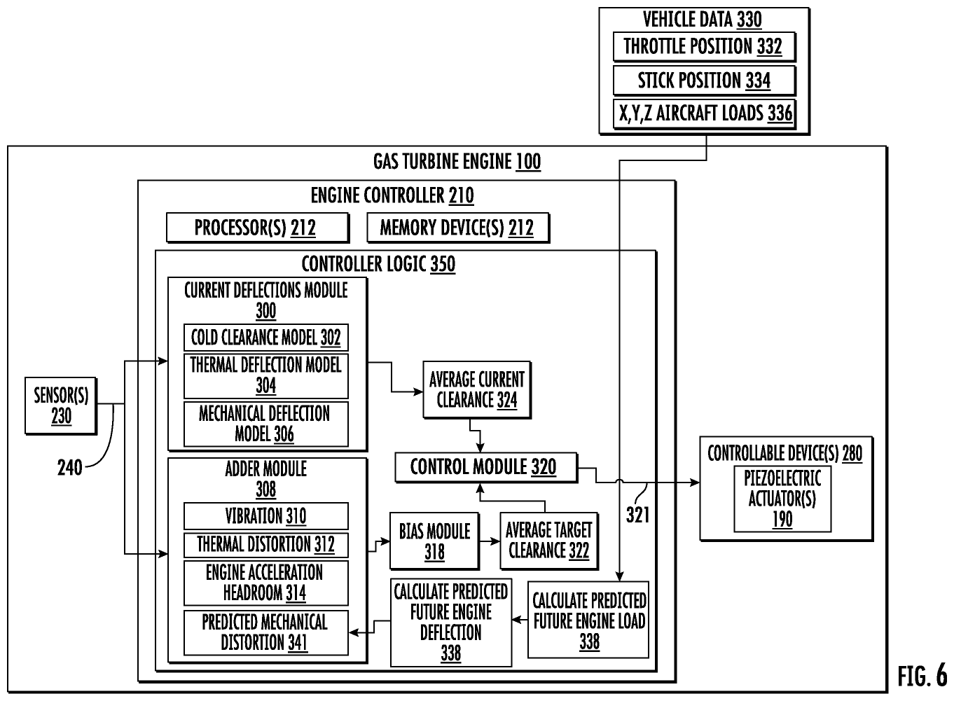

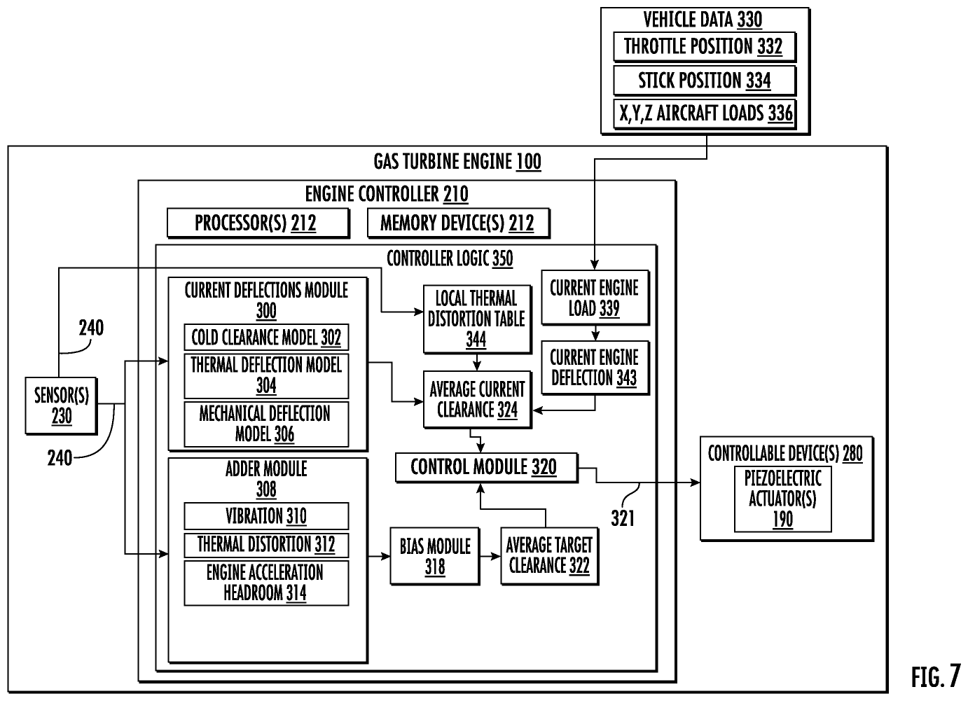

FIGS. 4 through 13 each provide a data flow diagram for implementing a clearance control scheme for the gas turbine engine 100 of FIG. 1. Particularly, FIGS. 6 through 15 provide a data flow diagram for a clearance control scheme that may be implemented in response to detecting an engine event. Although the clearance control scheme is described below as being implemented to control the clearances of the gas turbine engine 100 of FIG. 1, it will be appreciated that the clearance control scheme provided below may be implemented to control the clearances of other gas turbine engines having other configurations.

As shown in FIGS. 4 through 13, the gas turbine engine 100 includes an engine controller 210, one or more sensors 230, and one or more controllable devices 280. The engine controller 210 may be in operable communication with the one or more sensors 230, such that the engine controller 210 receives sensor data 240 from the sensors 230. Additionally, the engine controller 210 may be in operable communication with the controllable devices 280, which may include the piezoelectric actuators 190. In this way, the engine controller 210 may adjust the clearance CL between the blade tips 201 and the shroud segments 206 (FIGS. 2 and 3) by modulating the piezoelectric actuators 190. The one or more sensors 230 may be operable to capture values for various operating parameters and/or conditions associated with the gas turbine engine 100. The captured values, or sensor data 240, can be routed to the engine controller 210. The one or more sensors 230 can continuously capture operating parameter values, may do so at predetermined intervals, and/or upon a condition being satisfied.

The one or more sensors may include the sensors 230A, 230B, 230C, 230D. 230E, and 230F described above with reference to FIG. 1. For example, the sensors 230 may be operable to sense data indicative of one or more parameters of the fan section 104 (e.g., rotational speed, acceleration, torque on the rotor shaft driving the fan 134, etc.). Additionally, the sensors 230 may be configured to sense data indicative of one or more parameters in the compressors (such as a pressure or a temperature within the HP compressor 116, and/or a pressure or temperature within the LP compressor 114 etc.). Furthermore, the sensors 230 may be operable to sense data indicative of one or combustion section parameters (such as a temperature within the combustion section 118, a fuel flow to the combustion section 118, one or more pressures within or around the combustion section 118, etc.), one or more high pressure turbine parameters (such as turbine inlet temperature, a rotational speed of the HP turbine 122, etc.), or both. In various embodiments, the sensors 230 may be operable to sense data indicative of one or more parameters of the low pressure system (such as a rotational speed of the LP shaft 130). In various embodiments, the sensors 230 may be configured to sense data indicative of one or more parameters associated with the thrust bearings 80, such as but not limited to rotor thrust, bearing vibration (For example, non-synchronous vibration and/or Alford whirl induced non-synchronous vibration).

In many embodiments, the sensors 230 may be additionally or alternatively configured to sense data associated with the shroud segments and/or the rotor blades, such as indicative of a blade tip clearance between rotor blades and shroud segments, or such as data indicative of a contact force when the shroud segments contact the blade tips of the rotor blades, or other data. For example, the one or more sensors 230 can include at least one sensor operable to directly measure the clearance between a rotating component and a stationary component of the gas turbine engine 100. For instance, the one or more sensors 230 can include a sensor operable to measure the clearance between the turbine blade and the shroud segment. Such sensors can be optical probes, inductive proximity sensors, a combination thereof, or any suitable type of sensors operable to directly measure the clearance between their respective rotating and stationary components.

The one or more sensors 230 can also include other sensors as well. The one or more sensors 230 can include sensors operable to capture or measure operating parameter values for various operating parameters, such as various speeds, pressures, temperatures, etc. that indicate the operating conditions or operating point of the gas turbine engine 100. Example operating parameters include, without limitation, a shaft speed of the LP shaft 130, a shaft speed of the HP shaft 128, a compressor discharge pressure, an ambient temperature, an ambient pressure, a temperature along the hot gas path 174 between the HP turbine 122 and the LP turbine 124, an altitude at which the gas turbine engine 100 is operating, etc. Such sensors can measure or capture the operating parameter values for their respective operating parameters and such operating parameter values can be routed to the engine controller 210 as part of the sensor data 240 as depicted in FIGS. 4-13. The sensor data 240 can also include data indicating a power level of the gas turbine engine 100, e.g., based on a position of a throttle of the gas turbine engine 100.

In some embodiments, the engine controller 210 can also receive vehicle data 330. The vehicle data 330 can include sensed and/or calculated values associated with vehicle to which the gas turbine engine 100 is mounted. For instance, in embodiments where the vehicle to which the gas turbine engine 100 is mounted is an aerial vehicle (i.e., an aircraft), the vehicle data 330 can include a throttle position 332, a stick position 334, X, Y, Z engine loads, and X, Y,Z aircraft loads 336. The throttle position 332 may be a power demand (i.e., request for increased/decreased speed and/or acceleration relative to the current speed and/or acceleration). For example, if the throttle position 332 is increased, then the power demand may be increased and the gas turbine engine may accelerate. By contrast, if the throttle position 332 is decreased, then the power demand may be decreased and the gas turbine engine may decelerate.

The stick position 334 may determine the vehicle's future orientation (e.g., the aircraft's orientation in the air). For example, when the pilot moves the control stick (or yoke) to the left or right, the control stick moves (e.g., triggers movement, directly moves, etc.) ailerons on the wings of the aircraft, which in turn alters the lift and drag on the wings. The change in lift and drag on the wings causes the aircraft to bank or roll in the desired direction. If the pilot wants to turn left, for example, they will move the control stick to the left, which will raise the left aileron and lower the right aileron, causing the left wing to produce more lift and the right wing to produce less lift. This disparity in lift will result in the aircraft rolling to the left. Similarly, when the pilot moves the control stick or yoke forward or backward, it moves the elevators on the tail of the aircraft. This movement alters the pitch or angle of the aircraft's nose, causing the aircraft to climb or descend. If the pilot wants to climb, for example, they will move the control stick forward, which will lower the elevators, causing the nose of the aircraft to pitch up and the aircraft to climb.

The X, Y, Z aircraft loads 336 may include the loads on the aircraft along the X-axis, along the Y-axis, and/or along the Z-axis. The X-axis, also referred to as the longitudinal axis, runs from the nose to the tail of the aircraft. The loads acting along the X-axis are referred to as longitudinal loads, and they primarily arise due to changes in speed or altitude. When an aircraft accelerates or decelerates, it experiences a longitudinal load along the X-axis. Similarly, when an aircraft climbs or descends, it also experiences a longitudinal load. The Y-axis, also referred to as the lateral axis, runs from wingtip to wingtip. The loads acting along the Y-axis are referred to as lateral loads, and they primarily arise due to changes in roll. When an aircraft rolls to one side, it experiences a lateral load along the Y-axis. The Z-axis, also known as the vertical axis, runs perpendicular to the other two axes, from the top to the bottom of the aircraft. The loads acting along the Z-axis are referred to as vertical loads, and they primarily arise due to changes in pitch or turbulence. When an aircraft pitches up or down, it experiences a vertical load along the Z-axis. Similarly, the X, Y, Z engine loads may be the loads on the gas turbine engine along the X-axis, along the Y-axis, and/or along the Z-axis.

Additionally, the vehicle data 330 may include, without limitation, sensed and/or calculated parameter values associated with the aerial vehicle such as flight phase, inertial position, ground speed, inertial heading, thrust, drag, lift, weight, horizontal wind speed, wind direction, static pressure and temperature, flight intent parameters, etc.

The engine controller 210 includes controller logic 350. The controller logic can be a set of computer-executable instructions that, when executed by one or more processors of the engine controller 210, cause the one or more processors 212A to implement a clearance control scheme 355. In implementing the clearance control scheme 355, the one or more processors 212A can cause a clearance adjustment system, such as the active clearance control system 101 of FIG. 1, to adjust of a clearance between a rotating component and a stationary component of the gas turbine engine 100. For instance, implementation of a clearance control scheme can cause the clearance between a rotating component and a stationary component of the gas turbine engine 100 to be adjusted in any of the axial, radial, and/or circumferential directions.

As shown in FIGS. 4 through 13, the controller logic 350 may include a current deflections module 300, which may include one or more models for determining an average current clearance 324 (e.g., in real time in many embodiments). For example, the current deflections module 300 may receive the sensor data 240 from the one or more sensors 230, and the current deflections module 300 may determine at least partially based on the sensor data 240 the average current clearance 324. The average current clearance 324 may be a measured, calculated, and/or sensed value representative of the clearance CL between the blade tips 201 and the shroud segments 206. In some implementations, the average current clearance 324 may be an average clearance value for the entire circumference of the gas turbine engine 100 in the particular instance in time (e.g., an average of the radial clearances between each blade tip 201 and the respective shroud segment 206 about the entire circumferential direction C). Alternatively, in other implementations, the average current clearance 324 may include an average radial clearance value for each shroud segment 206 (e.g., a radial distance between the innermost surface of each shroud segment 206 and the nearest blade tip 201). The average current clearance 324 may be a distance that is less than an inch, e.g., within thousandths of an inch, for example.

The current deflections module 300 may include a cold clearance model 302, a thermal deflections model 304, and a mechanical deflections model 306. Each of the models 302, 304, and 306 may include an equation, set of equations, tables, graphs, and/or functions in order generate a value or values that are summed together to provide the average current clearance 324. For example, engine controller 210 may receive sensor data 240, such as sensor data indicative of an engine rotational speed and utilize the mechanical deflections model 306 to calculate the current mechanical expansion of the rotating components at least partially based on the sensor data 240. For example, the mechanical deflections model 306 may determine the mechanical expansion of the rotor 200 and the rotor blades 202 based at least partially on the rotational speed of the gas turbine engine 100 (e.g., the rotational speed of the rotor 200).

Regarding the thermal deflections model 304, the engine controller 210 may receive sensor data 240, such as data indicative of the speed of the gas turbine engine (e.g., the rotational speed of the HP shaft and/or the LP shaft), the temperature within the combustion section and/or the turbine section, and/or the pressure within the combustion section and/or the turbine section, and the engine controller 210 may utilize the thermal deflections model to calculate or determine the thermal deflection of the components within the turbine section. For example, the thermal deflections model may calculate in real time the thermal deflections (such as the thermal expansion or retraction) of the rotor 200, the rotor blades 202, the casing 204, the shroud segments 206, the hangers 208, and other components in the turbine section 123.

The cold clearance model 302 may be included in the current deflections module 300 to account for variances in the cold clearance between gas turbine engines caused by manufacturing and/or assembly tolerances. The cold clearance model 302 may be a baseline value or parameter that accounts for variances in the cold clearance (i.e., the clearance between the blade tips 201 and the shroud segment 206 when the gas turbine engine is not operating and at ambient temperature/pressure). As discussed below, the cold clearance model 302 may be advantageously eliminated by utilizing the piezoelectric actuators 190 to determine the exact gas turbine engine 100 cold clearance on an engine-by-engine basis (e.g., a cold clearance value specific to the gas turbine engine 100 rather than a parameter that accounts for all the variances in cold clearance).

The adder module 308 may include one or more look up tables 309 which may receive one or more inputs (such as the sensor data 240) and may generate one or more outputs. Particularly, the one or more lookup tables may be a data structure used by the engine controller 210 controller to convert an input data (such as the sensor data 240 and/or vehicle data 330) into an output value. The look up tables may include a list of input values and their corresponding output values, which are precomputed and stored in the look up table. During operation of the gas turbine 100. the engine controller 210 receives the sensor data 240 and uses it as an index to look up the corresponding output value from the look up table. The look up table then generates an output based on the received sensor data 240, which is used as a lookup value.

In many embodiments, the adder module 308 may include a vibration look up table 310, an engine acceleration headroom look up table 314, and a worst mechanical distortion look up table 316. The worst mechanical distortion look up table 316 may utilize the sensor data 240 (which includes data indicative of operating conditions of the gas turbine engine 100, such as an engine speed, temperature, and/or pressure) as a lookup value to determine a worst mechanical distortion value(s) (e.g., a worst case mechanical distortion based on the engine operating conditions, which may be based on historical engine operating data) associated with the various components of the turbine section 123 (such as the rotor 200, the rotor blades 202, the casing 204, the stator segments 206, and/or the hangers 208). The vibration look up table 310 may use the sensor data 240 (which includes data indicative of operating conditions of the gas turbine engine 100, such as an engine speed, temperature, and/or pressure) as a lookup value to determine an engine vibration associated with the operating conditions of the gas turbine 100. Likewise, the thermal distortion look up table 344 may utilize the sensor data 240 (which includes data indicative of operating conditions of the gas turbine engine 100, such as an engine speed, temperature, and/or pressure) as a lookup value to determine an a thermal distortion value(s) associated with the thermal distortion of the various components of the turbine section 123 (such as the rotor 200, the rotor blades 202, the casing 204, the stator segments 206, and/or the hangers 208). Similarly, the engine acceleration headroom look up table 314 may utilize the sensor data 240 (which includes data indicative of operating conditions of the gas turbine engine 100, such as an engine speed, temperature, and/or pressure) as a lookup value to determine an engine acceleration headroom value (i.e., the clearance needed to the mechanical expansion of the rotary components caused by acceleration of the gas turbine engine). In many embodiments, the output of the adder module 308 may be provided to a bias module 318, which may offset or deviate the output of the adder module 308 by a constant value in order to determine the average target clearance 322. The target clearance 322 may be a calculated value that corresponds with an ideal clearance based on the present operating conditions of the gas turbine engine 100. For example, the target clearance 322 may be the clearance corresponding with maximum efficiency and/or performance of the gas turbine engine for a given set of operating conditions (e.g., the target clearance may be different based on different operating conditions). Particularly, in exemplary embodiments, the target clearance may be about 5% of the maximum possible clearance (e.g., if the clearance adjustment system retracted the stationary component as far as possible).

In many embodiments, the controller logic 350 may compare the average current clearance 324 and the average target clearance 322 for each of the shroud segments to determine whether a clearance adjustment is necessary. For example, the control module 320 may determine whether the average current clearance 324 is within a predetermined margin of the average target clearance 322 for each of the shroud segments 206. The predetermined margin may be a +15% margin of the average target clearance 322, or such as a +10% margin of the average target clearance 322, or such as a +5% margin of the average target clearance 322, or such as a +1% margin of the average target clearance 322. The average current clearance 324 for a particular shroud segment 206 is within the predetermined margin of the average target clearance 322 when the average current clearance 324 neither exceeds a maximum margin threshold nor falls below a minimum margin threshold. Likewise, the average current clearance 324 for a particular shroud segment 206 is outside the predetermined margin when the average current clearance 324 either exceeds the maximum margin threshold or falls below a minimum margin threshold.

In many embodiments, the control module 320 may generate one or more control signals 321 as an output, which may be provided to the controllable devices 280. For example, the control module 320 may adjust the clearance CL based on the comparison between the average current clearance 324 and the average target clearance 322. For example, when the average current clearance 324 is outside of the predetermined margin of the average target clearance 322 (e.g., either exceeds the maximum margin threshold or falls below a minimum margin threshold), then the control module 320 may generate a control signal 321 that adjusts (e.g., increases or decreases) the piezoelectric actuators 190, which adjusts the clearance CL. Particularly, if the average current clearance 324 exceeds the maximum margin threshold of the predetermined margin of the average target clearance 322, then the clearance CL rate may be reduced by extending the piezoelectric actuators 190. By contrast, if the average current clearance 324 falls below the minimum margin threshold of the predetermined margin of the average target clearance 322, then the clearance CL rate may be increased by retracting the piezoelectric actuators 190. The control module 320 may maintain the average current clearance 324 within +5% of the average target clearance 322. For example, if the average current clearance exceeds+5% of the average target clearance 322, then the control module 20 may generate a control signal 321 that adjusts (e.g., increases or decreases) the piezoelectric actuators 190, which adjusts the clearance CL.

In many implementations, the gas turbine engine 100 may undergo or be subjected to one or more engine events. The engine events may include a cold clearance zeroing event, a vehicle maneuver, an engine acceleration event, a stall event, a bowed rotor start event, a non-synchronous vibration (NSV) event, an Alford whirl NSV event, and/or a high rotor thrust event. The controller logic 350 of the engine controller 210 may be operable to determine which engine event is occurring or being executed and independently adjust the clearances CL between each shroud segment 206 and the blade tips 201 to maximize performance of the gas turbine engine 100.

For example, as shown in FIG. 5, the controller logic 350 may include a cold clearance calibration module 325 for executing a cold clearance zeroing (or calibration) event when the gas turbine engine 100 is fully assembled and at ambient temperature and/or pressure. Particularly, the controller logic 350 may determine the cold clearance (i.e., the clearance between each of the shroud segments 206 and the corresponding blade tips 201 when the gas turbine engine is not operating and at ambient temperatures and/or pressures). In this way, the cold clearance model 302 shown in FIG. 4 (which accounts for cold clearance in the gas turbine engine by using aggregated historical gas turbine data) may be eliminated because the actual cold clearance for the gas turbine engine 100 may be determined by using the piezoelectric actuators 190.

For example, the engine controller 210 may cause the clearance adjustment system to actuate the piezoelectric actuators 190 such that each of the shroud segments 206 move from a starting position to a contact position in which each of the shroud segments 206 contact a blade tip 201. In such embodiments, the sensors 230 may be operable to sense data indicative of a contact force between the shroud segments 206 and the blade tips 201 and provide the data to the cold clearance calibration module 325 as cold clearance data, such that the engine controller 210 can determine when the shroud segments 206 are contacting the blade tips 201 (e.g., the piezoelectric actuators 190 are in the contact position) based on the cold clearance data. Subsequently, the engine controller 210 may cause the clearance adjustment system to actuate the piezoelectric actuators 190 back to the starting position, and the engine controller 210 may determine the cold clearance (e.g., the radial distance between the shroud segments 206 and the blade tips 201 when the piezoelectric actuators 190 are in the starting position). In exemplary implementations, the cold clearance may be utilized by the engine controller 210 for generating the average current clearance 324. For example, the thermal deflections model 304 may utilize the cold clearance as a starting value, such that any thermal expansion of the various components may be added/subtracted relative to the starting value. For example, if the engine controller determines that the cold clearance is between about 1 inch and about 5 inches, then the thermal deflections model 304 may utilize this cold clearance as a starting value, such that any calculated thermal expansion of the various components may be added/subtracted relative to the starting value.

Referring now to FIG. 6, the control logic 350 may additionally or alternatively include steps for addressing a vehicle maneuver (such as an aircraft maneuver). An aircraft maneuver refers to a deliberate change in the flight path or attitude of an aircraft. The engine controller 210 may predict when such aircraft maneuvers will be performed and may adjust a clearance CL between one or more of the shroud segments 206 and the blade tips 201 in response to determining the maneuver to optimize performance and/or efficiency of the gas turbine engine 100.

For example, the engine controller 210 may receive the current stick position 334 (i.e., the current yaw, pitch, and/or roll from the aircraft) and the current X. Y. Z aircraft loads 336 from the vehicle data 330. The engine controller 210 may utilize this data to calculate the predicted future engine load at (338). That is, the engine controller 210 may predict what the future X, Y, Z engine loads will be (e.g., forward in time) experienced as a result of the vehicle maneuver based on the current X, Y, Z aircraft loads 336 and the current stick position 334. For example, if the pilot shifts the stick to the left to make a turn, the engine controller 210 may receive the stick position 334 and the current X, Y, Z aircraft loads as the vehicle data 330, and the engine controller 210 may predict what the engine loads will be when the aircraft is performing the left turn. As a result, the engine controller 210 may determine a predicted mechanical distortion of one or more engine components at least partially based on the future X, Y, Z engine loads (i.e., how much the rotating components will mechanically expand/contract as a result of the vehicle maneuver). Subsequently, the engine controller 210 may generate the current clearance at least partially based on the determined predicted mechanical distortion. That is, the engine controller 210 may cause the clearance adjustment system to adjust the clearance at least one of before, during, and/or after the vehicle maneuver based on the predicted mechanical distortion and/or based on the current mechanical distortion.

Based on the predicted future engine loads, the controller logic 350 may include at (340) calculating the predicted future engine deflection 340. In such implementations, the engine controller 210 may cause the clearance adjustment system to adjust the clearance CL by actuating the piezoelectric actuator 190 based on the predicted future engine deflection.

Particularly, the predicted future engine deflection calculated by the engine controller 310 may be provided to the adder module 308 as mechanical distortion 341. Contrary to the worst mechanical distortion 316 shown and described above with reference to FIG. 4, the predicted mechanical distortion 341 is an actual mechanical distortion value based on gas turbine operating conditions (e.g., based on the vehicle data 330 and the sensor data 240), instead of a worst-case value generated by a look up table as in FIG. 4. The predicted mechanical distortion 341 may be utilized by the engine controller for determining the average target clearance 322, such that the piezoelectric actuators 326 may be adjusted at least partially based on the predicted mechanical distortion 341.

In this way, when the aircraft is about to perform a maneuver, the engine controller 210 may determine the mechanical distortions that will occur during the maneuver, and the clearance CL between each shroud segment 206 and the blade tips 201 may be independently adjusted to account for the determined mechanical distortions that will occur during the maneuver.

Referring now to FIG. 7, the controller logic 350 may include one or more steps for addressing when the engine event is a vehicle maneuver. For example, in addition to determining the predicted mechanical distortion 341 and utilizing the predicted mechanical distortion 341 to calculate the average target clearance 322, the engine controller 210 may determine a current mechanical distortion 342 (and/or a current thermal distortion) and utilize the current mechanical distortion 342 for calculating the average current clearance 324. That is, the engine controller 210 may determine when a vehicle maneuver is being performed and may adjust a clearance CL between one or more of the shroud segments 206 and the blade tips 201 in response to determining the maneuver to optimize performance and/or efficiency of the gas turbine engine 100.

For example, the engine controller 210 may receive the current stick position 334 (i.e., the current yaw, pitch, and/or roll from the aircraft) and the current X. Y. Z aircraft loads 336 from the vehicle data 330. The engine controller 210 may utilize this data to calculate the current engine load at (339). For example, if the pilot shifts the stick to the left to make a turn, the engine controller 210 may receive the stick position 334 and the current X, Y, Z aircraft loads as the vehicle data 330, and the engine controller 210 may determine what the engine loads are as the aircraft is performing the left turn. Based on the determined current engine loads, the controller logic 350 may include at calculating the current engine deflection 343 of one or more gas turbine components, such as the mechanical deflection of the rotor 200, the rotor blades 202, the shroud segments 206, the casing 204, or other components in the turbine 123 caused by performance of the aircraft maneuver. In such implementations, the engine controller 210 may cause the clearance adjustment system to adjust the clearance CL by actuating the piezoelectric actuator 190 based on the current engine deflections 343.

Additionally, the engine controller 210 may include a local thermal distortion table 344, and the average current clearance 324 may be determined at least partially based on the local thermal distortion table 344. The local thermal distortion table may include thermal distortion characteristics of the specific components in the turbine 123, such as the rotor 200, the rotor blades 202, the shroud segments 206, the casing 204, or others.

In this way, when the aircraft is performing maneuvers, the engine controller 210 may determine the current mechanical distortions 343 that are occurring during the maneuver, and the clearance CL between each shroud segment 206 and the blade tips 201 may be independently adjusted (e.g., by actuating the piezoelectric actuators 190) to account for the current mechanical distortions 343.

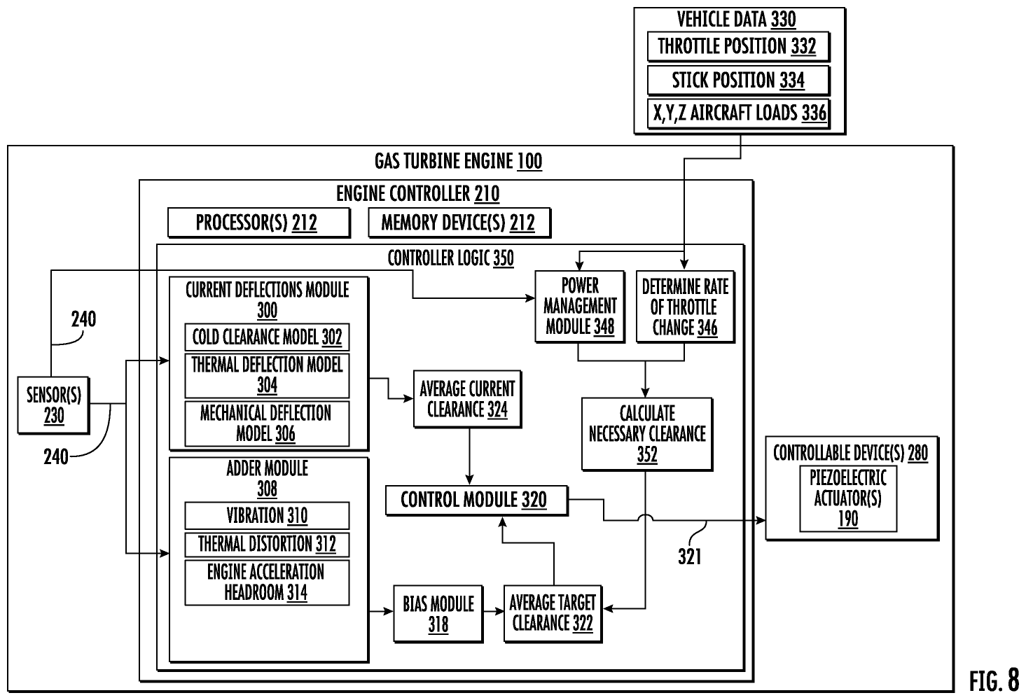

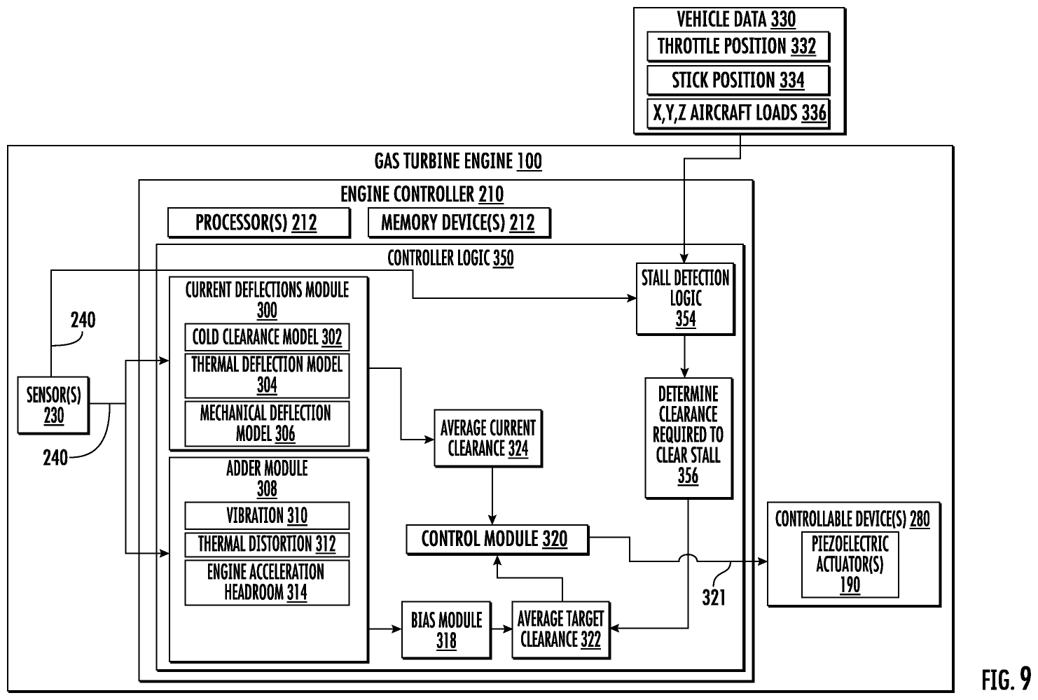

Referring now to FIG. 8, as shown, the controller logic 350 may include one or more steps for addressing when the engine event is an engine acceleration event (i.e., when the gas turbine engine is accelerating, which causes mechanical expansion of the rotating components). In such embodiments, the engine controller 210 may receive acceleration data indicative that the gas turbine engine is engaged in an engine acceleration event. For example, the engine controller may receive the throttle position 332 (e.g., the power demand) from the vehicle data 330. Particularly, the engine controller 210 may receive data indicative of change in power demand (e.g., a change in throttle position and/or angle, which signals an increase/decrease in power demand). In response, the engine controller 210 may determine a predicted mechanical deflection of the rotating components, which will be caused as a result of the engine acceleration event. Subsequently, the engine controller 210 may determine an acceleration clearance (or required clearance) that is required to prevent a rub event based on the determined predicted mechanical deflection of the second component. That is, once the engine controller determines a predicted mechanical deflection, the engine controller may determine how much clearance (i.e., headroom) is needed to account for the mechanical expansion of the rotating components that will occur during the engine acceleration event. For example, the engine controller may determine that an additional 0.1 inches of headroom (or clearance) is necessary to perform an engine acceleration event without causing rub. The engine controller 210 may generate the target clearance 322 at least partially based on the acceleration clearance required to prevent a rub event (e.g., in order to ensure enough clearance or headroom is available for the rotating components during the acceleration event).

Particularly, the controller logic 350 may receive the throttle position 332 from the vehicle data 330 and at (346) may determine the rate of throttle change. That is, the engine controller 210 may determine if the throttle angle has increased (i.e., whether or not the power demand has increased, which signals an acceleration event).

Additionally, the controller logic 350 may receive the throttle position 332 and provide the throttle position 332 to a power management module 348. The power management module 348 may control the amount of thrust produced by the gas turbine engine 100 in order to achieve the desired level of performance and efficiency. This can be done by adjusting the gas turbine engine's fuel flow, air intake, and other parameters to optimize the engine's performance. Additionally, the power management module 348 may determine if enough speed excursion is available to increase the power (e.g., the thrust) of the gas turbine engine without negatively impacting other gas turbine performance parameters. Stated differently, the power management module 348 may receive sensor data 240 from the sensors 230 indicative of operating conditions in the gas turbine engine 100 and may receive the request for increased power demand indicated by the change in throttle position 332, and the power management module 348 may determine if the gas turbine engine 100 has available speed excursion (i.e., whether or not the gas turbine engine 100 has the ability to operate at the requested speed and power setting without negatively impacting other parameters).

If the power management module 348 determines there is enough speed excursion available, the controller logic 350 may include at (352) calculating the acceleration clearance. For example, the rotating components will experience mechanical and thermal expansion as a result of the acceleration event, and the controller logic 350 may determine how much additional clearance is required to compensate for the mechanical and thermal expansion during the acceleration event without causing a rub or pinch event. The average target clearance 322 may be determined at least partially based on the calculated acceleration clearance. As such, the control module 320 may actuate the piezoelectric actuators 190 to adjust the clearance CL according to the acceleration clearance to achieve the acceleration event without causing a pinch/rub with the stator segments 206.

Referring now to FIG. 9, as shown, the controller logic 350 may include one or more steps for detecting and addressing when the engine event is a stall event by adjusting the clearance CL in the turbine 123. A stall event may occur as a result of aerodynamic instability within the turbine section (e.g., turbine stall) and/or the compressor section (e.g., compressor stall), which disrupts the airflow through the compressor section and/or the turbine section. The stall event can cause a sudden decrease in the gas turbine engine's power output and potentially damage the engine.

As shown in FIG. 9, the sensor data 240 and the vehicle data 330 may be received by the engine controller 210 and utilized by the stall detection logic 354 for determining whether or not a stall event is occurring in the gas turbine engine 100 (e.g., whether or not a compressor stall and/or turbine stall is present).

The stall detection logic 354 may be operable to identify when one of the compressors and/or one of the turbines has entered an aerodynamically unstable condition (e.g., when the gas turbine engine is experiencing a stall event) and may be capable of recovering the aerodynamically unstable compressor and/or turbine from stalling conditions by adjusting the clearance within turbine by actuating the piezoelectric actuators 190. More specifically, using sensor data 240 indicative of a one of a pressure or a temperature within the compressor and/or the turbine, the system may determine if one of the compressors or turbines has entered an aerodynamically unstable condition (e.g. entered the threshold of a stall condition and/or is actively in a rotational stall). As will be appreciated, the term “rotating stall” generally refers to a local disruption of airflow within a compressor or turbine which continues to provide working fluid (such as air or combustion gases), but with reduced effectiveness. Rotating stall may arise when a small proportion of airfoils experience airfoil stall, disrupting the local fluid flow without destabilizing the compressor and/or turbine. The stalled airfoils may create pockets of relatively stagnant fluid which, rather than moving in the flow direction, rotate in a circumferential direction C of the compressor and/or turbine. In certain exemplary embodiments, there may only be one “stalled” airfoil, but the rotating stall may grow from there, propagating to a plurality of airfoils, creating a surge of stalled airfoils.

In order to combat a compressor and/or a turbine experiencing rotating stall (or exit the aerodynamically unstable conditions), the engine controller 210, at (356), may determine the clearance required to clear the stall event. The average target clearance 322 may be modified and/or calculated at least partially based on the determined clearance required to clear the stall event.

The clearance may be adjusted by actuating the piezoelectric actuators until the rotating stall has been cleared and the aerodynamically unstable compressor and/or turbine returns to normal operation. For example, in response to sensing data indicative of conditions within a predetermined range of a compressor and/or turbine stall event, the engine controller may adjust (e.g., increase or decrease) the clearance CL between the blade tips 201 and the shroud segments 206 by actuating the piezoelectric actuators 190 until the rotating stall has been cleared and the aerodynamically unstable compressor and/or turbine returns to normal operation.

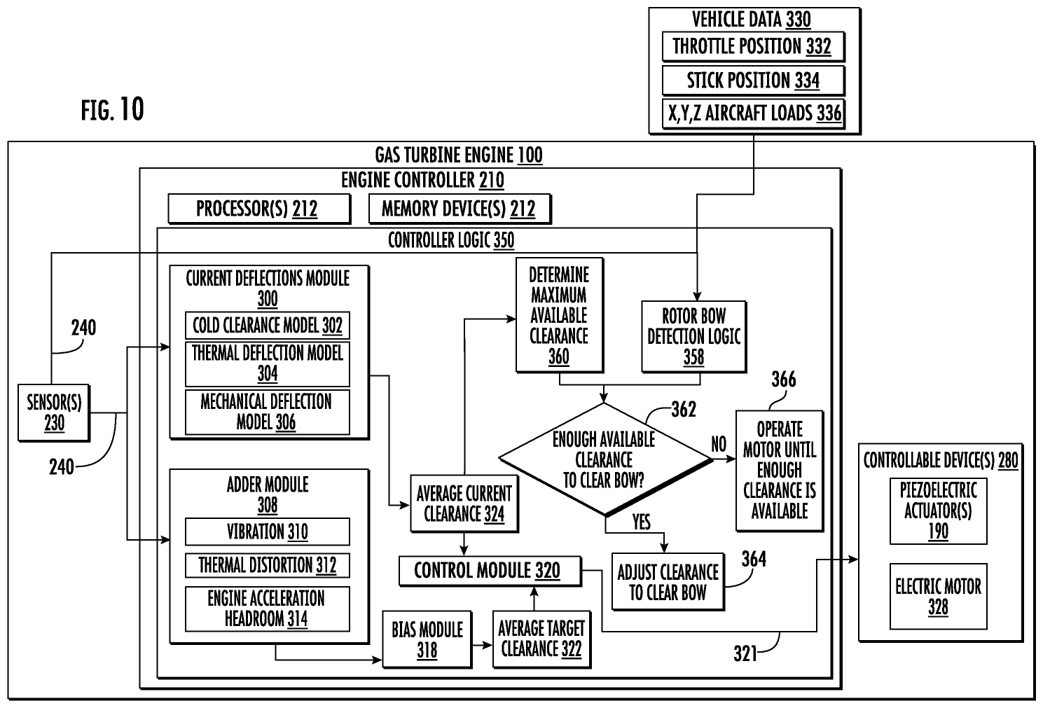

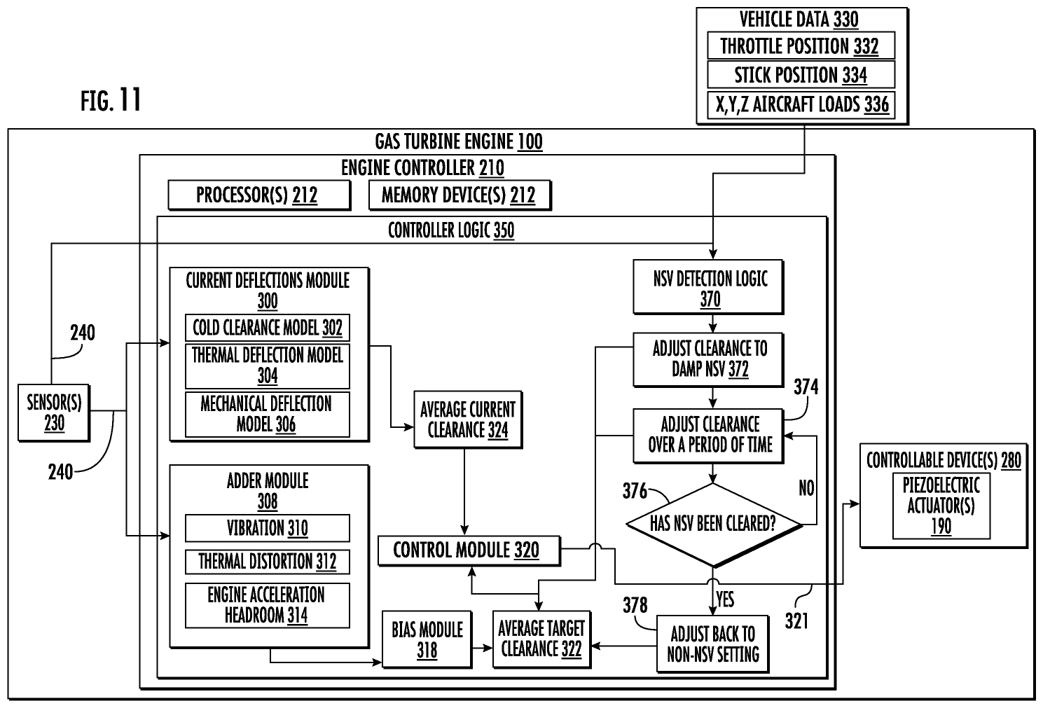

Referring now to FIG. 10, the controller logic 350 may include one or more steps for detecting and addressing when the engine event is a bowed rotor start event (in which the gas turbine engine 100 is shut off and the rotor 200 is in a bowed condition) by adjusting the clearance CL in the turbine 123. After a gas turbine engine has been operated and is then shut off, the engine is hot and due to heat rise, the upper portions of the engine will be hotter than lower portions of the engine. When this occurs, thermal expansion may cause deflection of components of the engine, such as the rotor. If the engine is started or attempted to be started while the components are deflected, such a start is termed a “bowed rotor start” condition or event. During a bowed rotor start event, the rotor can experience high unbalanced vibrational loads and high eccentricity, and the rotor blades may not have enough clearance to rotate without contacting the shroud segments due to the bowed rotor.

After the gas turbine has been operated and is shut off, the rotor bow detection logic 358 may be operable to identify when the rotor is in a bowed condition at least partially based on the sensor data 240 indicative of a temperature, a pressure, and/or a vibration within the gas turbine engine 100. For example, in many implementations, the rotor bow detection logic 358 may determine whether the sensor data 240 indicative of a vibration, temperature, and/or pressure within gas turbine engine is greater than a bowed rotor threshold (such that the rotor is in a bowed condition). Additionally, or alternatively, the rotor bow detection logic 358 may include determining a curvature and/or the inflection points of the rotor in the bowed condition, which may be done by a look up table based on the temperatures of the rotor, or may be done by one or more calculations based on the temperatures of the rotor. Once the curvature and/or the inflection points of the rotor are determined, the engine controller may determine a radial magnitude of the bowed rotor (e.g., how radially offset the rotating components, such as the rotor blades, are offset from normal conditions due to the bowed rotor condition). The engine controller 210 may determine a required clearance based at least in part on the curvature, inflection points, and/or the magnitude of the bowed rotor. The required clearance may be the clearance necessary to allow the rotor in a bowed rotor condition to rotate without causing rub/pinch between the rotor blades and the shroud segments. The required clearance for a bowed rotor restart may be larger than the clearance required for starting a gas turbine engine under cold rotor conditions (e.g., the required clearance for bowed rotor restart may be 10% larger than cold rotor conditions, or 20% larger, or 30% larger). Further, the controller logic 350 may include, at (360), determining the maximum available clearance within the turbine. That is, the controller logic 350 may determine how much the stator segments can be retracted by actuating the piezoelectric actuators 190 while still being extended enough to start the gas turbine engine 100 (e.g., too much fluid isn't flowing over the rotor blades, but rather through them).

The controller logic 350 may further include at (362) determining whether the maximum clearance is large enough to clear the bowed condition. That is, the controller logic 350 may determine whether the maximum available clearance large enough to allow the rotor in a bowed rotor condition to rotate without causing rub/pinch between the rotor blades and the shroud segments (i.e., the maximum clearance exceeds the required clearance).

If enough clearance is available to clear the bowed rotor condition (e.g., the maximum available clearance is larger than the required clearance), the engine controller 210 may, at (364), adjust the clearance to clear the bowed rotor and start the gas turbine engine. The engine controller 210 may adjust the clearance to be between about 0.1% and about 20% larger than the required clearance, or such as between about 0.1% and about 15% larger than the required clearance, or such as between about 0.1% and about 10% larger than the required clearance, or such as between about 0.1% and about 5% larger than the required clearance while still being less than the maximum available clearance. Subsequently, or simultaneously, the engine controller 210 may start the gas turbine engine 100.

If enough clearance is not available to clear the bowed rotor condition (e.g., the maximum available clearance is smaller than the required clearance), the engine controller 210 may, at (366), operating an electric motor 328 to rotate the rotor in the bowed condition until enough clearance is available to clear the bowed rotor condition (e.g., the maximum available clearance is smaller than the required clearance). That is, the engine controller 210 may rotate the rotor in the bowed condition with an electric motor 328 (which is one of the controllable devices 280) while keeping the gas turbine engine 100 shut off until enough clearance is available to clear the bowed rotor condition (e.g., the maximum available clearance is smaller than the required clearance).

Referring now to FIG. 11, as shown, the controller logic 350 may include one or more steps for detecting and addressing when the engine event is a non-synchronous vibration (NSV) event by adjusting the clearance CL in the turbine 123. NSV may occur in a thrust bearing (such as the thrust bearings 80 discussed above with reference to FIG. 1) of a gas turbine engine. NSV in a thrust bearing refers to vibrations that occur at a frequency that is not directly related to the rotational speed of the engine.

The NSV detection logic 370 may be operable to identify when the thrust bearings are experiencing NSV at least partially based on the sensor data 240 indicative a vibration in the thrust bearings and/or the sensor data 240 indicative of a rotational speed of the gas turbine engine 100. For example, the one or more sensors 230 may be configured to sense data indicative of one or more parameters associated with the thrust bearings, such as but not limited to rotor thrust (which can induce NSV), vibration within the bearings, or other parameters associated with the thrust bearings. The NSV detection logic 370 may identify an NSV condition when the data indicative of a vibration within the thrust bearing is not related to the engine speed.

The phrase “related to engine speed” may refer to when the frequency of the vibration within the thrust bearing is directly or indirectly proportional to the rotational speed of the aircraft engine. In other words, the frequency of the vibration within the thrust bearing is a multiple of the engine speed or a submultiple of the engine speed. By contrast, if the frequency of the vibration is not directly or indirectly proportional to the engine speed, it is considered non-synchronous vibration. As such, the NSV detection logic 370 may determine when NSV is present within the thrust bearings by comparing the sensor data 240 indicative of a vibration within the thrust bearing with the sensor data 240 indicative of a rotational speed of the gas turbine engine 100.

In response to determining an NSV event in the thrust bearings, the controller logic 350, at (372), may adjust the clearance CL to damp the NSV. That is, the controller logic 350, at (374), may adjust (e.g., increase and/or decrease) the clearance CL over a period of time to damp the NSV. Once the period of time is over, the controller logic 350 may include, at (376), determining whether the NSV event has been cleared. If so, the controller logic 350 may, at (378) adjust the clearance back to a non-NSV setting. If not, the controller logic 350 may repeat blocks 374 and 376 until the NSV event has been cleared.

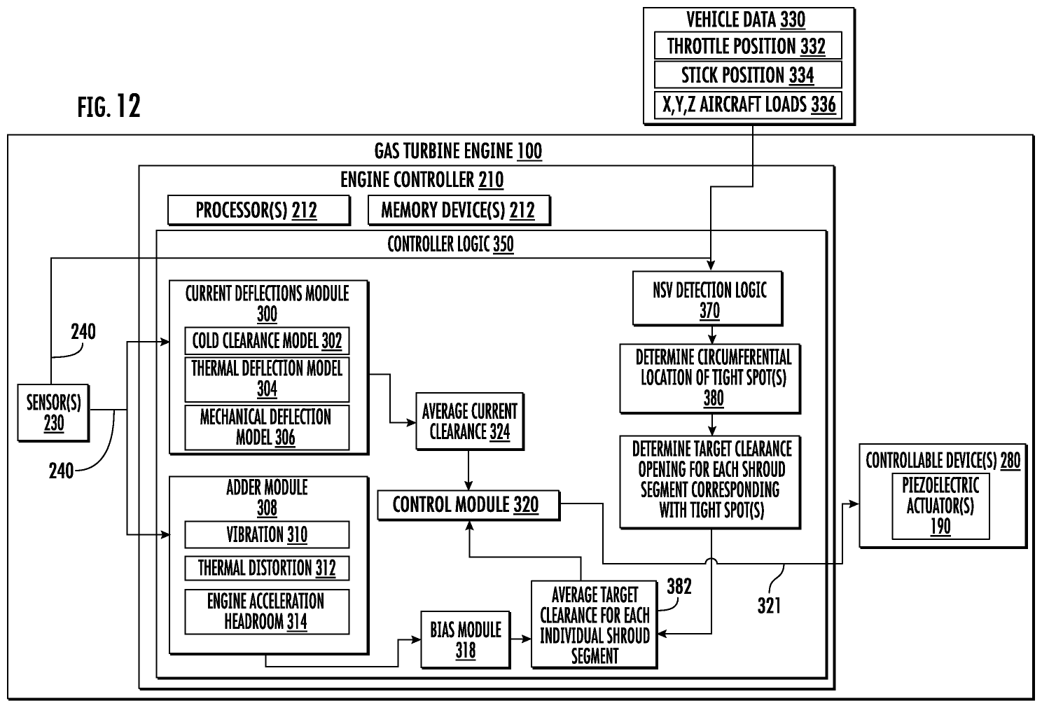

Referring now to FIG. 12, as shown, the controller logic 350 may include one or more steps for detecting and addressing when the engine event is a non-synchronous vibration (NSV) event by adjusting the clearance CL in the turbine 123.

Particularly, the controller logic 350 shown in FIG. 12 may address when the NSV event occurs in a thrust bearing (such as the thrust bearings 80 discussed above with reference to FIG. 1) due to Alford whirl. Alford whirl is a type of non-synchronous vibration that can occur in aircraft engine thrust bearings. It is caused by the interaction between the oil film in the thrust bearing and the rotating components of the engine. In a thrust bearing, a thin layer of oil separates the rotating components from the stationary housing, allowing for smooth rotation and reduced friction. As the engine operates, the oil film can become destabilized by the forces generated by the rotating components. This can cause the oil film to whirl, or rotate in a circular motion, around the inside of the thrust bearing. If the speed and direction of the whirling oil film align with the natural frequency of the bearing or surrounding structures, it can lead to resonance and non-synchronous vibration.

The NSV detection logic 370 may be operable to identify when the thrust bearings are experiencing NSV caused by Alford whirl at least partially based on the sensor data 240 indicative a vibration in the thrust bearings and/or the sensor data 240 indicative of a rotational speed of the gas turbine engine 100. For example, the one or more sensors 230 may be configured to sense data indicative of one or more parameters associated with the thrust bearings, such as but not limited to rotor thrust (which can induce NSV), oil speed within the thrust bearings, vibration within the bearings, or other parameters associated with the thrust bearings. The NSV detection logic 370 may identify an NSV condition caused by Alford whirl when the data indicative of a vibration within the thrust bearing is not related to the engine speed.

In response to determining an NSV event in the thrust bearings caused by Alford whirl, the controller logic 350, at (380), may determine the circumferential location of one or more tight spots. That is, the engine controller 210 may identify a circumferential location of minimum clearance (e.g., minimum radial clearance) between at least one shroud segment 206 of the plurality of shroud segments 206 and the blade tips 201 of the rotor blades 202. For example, the engine controller 210 may identify which shroud segment 206 of the plurality of shroud segments 206 is closest to a blade tip 201 of the plurality of blade tips 201, and the location of this shroud segment 206 may be the circumferential location of minimum clearance. In response, the engine controller 210, at (381), may determine a target clearance opening for each shroud segment 206 of the plurality of shroud segments 206 that have a tight spot (e.g., that correspond with a circumferential location of minimum clearance). The engine controller 210, with the clearance adjustment system, may adjust a position (e.g., a radial position, a circumferential position, and/or an axial position) of the at least one shroud segments 206 corresponding with the circumferential location of minimum clearance by independently actuating the piezoelectric actuator 190 coupled to the at least one shroud segment 206. This may advantageously stop the Alford whirl induced NSV in the thrust bearings 80.

Particularly, the engine controller 210 may adjust, at (382), the average target clearance for each shroud segment of the plurality of shroud segments in response to determining the at least one shroud segments corresponding with the circumferential location of minimum clearance, thereby causing each of the shroud segments to be independently moved relative to one another.

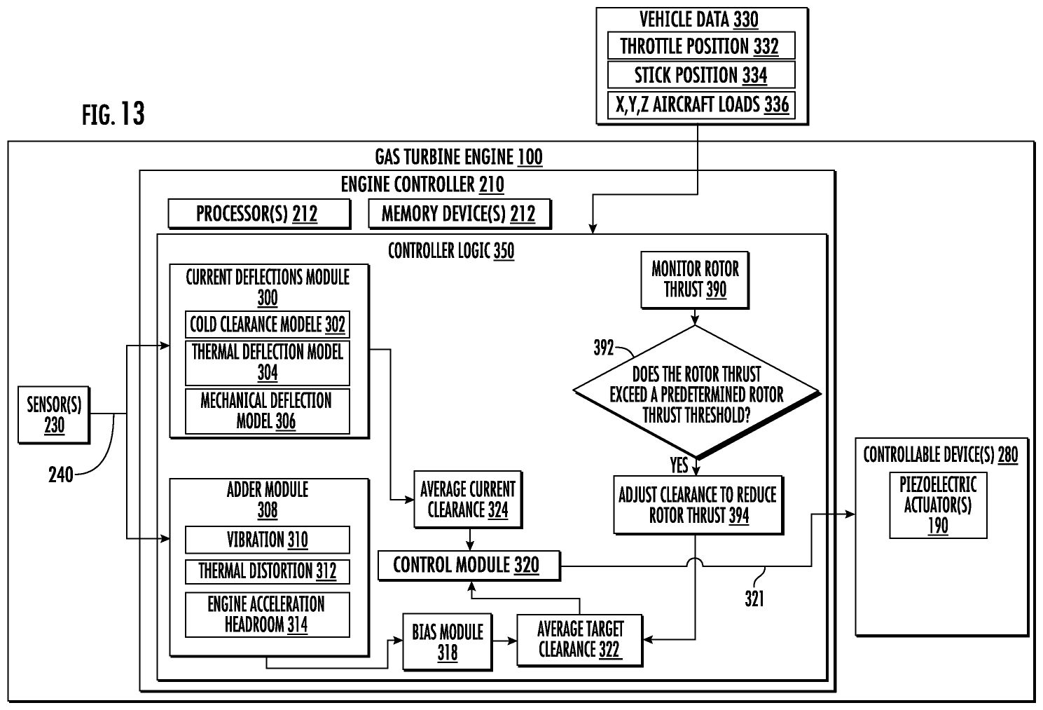

Referring now to FIG. 13, as shown, the controller logic 350 may include one or more steps for detecting and addressing when the engine event is a high rotor thrust event by adjusting the clearance CL in the turbine 123. Particularly, a high rotor thrust event may occur when a thrust bearing (such as one of the thrust bearings 80 described above with reference to FIG. 1), experiences an axial thrust (e.g., an axial force) in excess of the intended design, which can lead to damage to the thrust bearing. For example, the controller logic 350 may include, at (390), monitoring the rotor thrust in the thrust bearing (e.g., by continuously receiving the sensor data 240 indicative of a rotor thrust experienced by the thrust bearing). For example, the engine controller 210 may receive sensor data 240 indicative of an axial force (or thrust) experienced by the thrust bearing 80.

At (392), the engine controller 210 may determine whether the data indicative of a rotor thrust in the thrust bearing exceeds a predetermined rotor thrust threshold. If so, then at (394), the engine controller 210 may adjust the clearance to reduce the rotor thrust. For example, the engine controller 210 may generate the target clearance at least partially based on determining that the sensor data 240 indicative of rotor thrust in the gas turbine engine exceeds the predetermined rotor thrust threshold, thereby causing the control module 320 to adjust the clearance by actuating the piezoelectric actuators 190.

Adjusting a clearance may include adjusting, with the piezoelectric actuators 190, a position of one or more shroud segments 206 of the plurality of shroud segments 206 in any of the radial, axial, or circumferential directions.

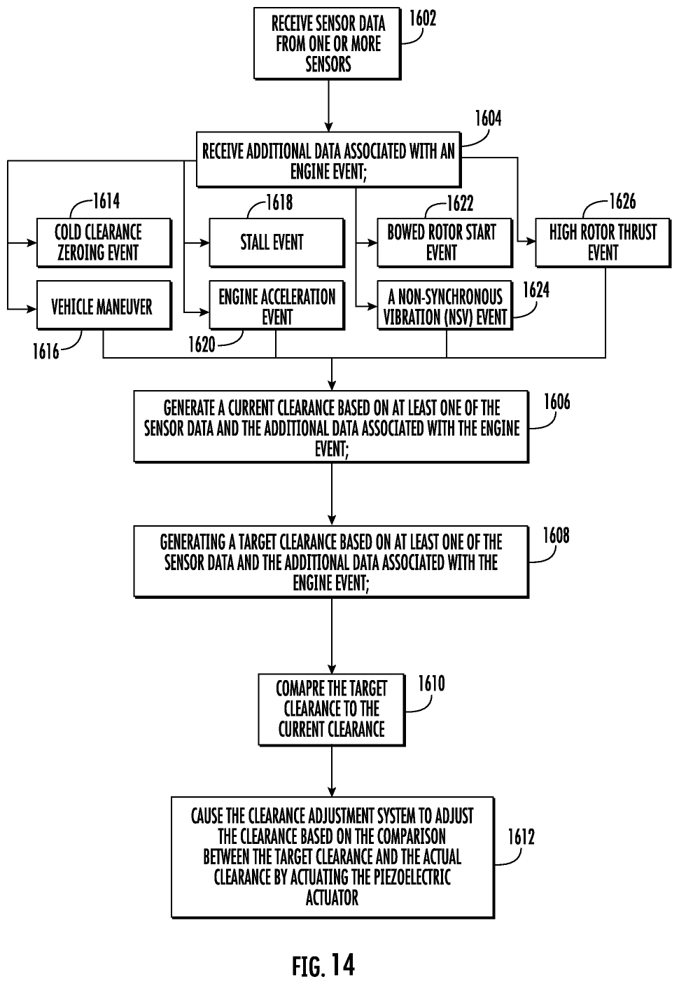

Referring now to FIG. 14, a flow diagram of one embodiment of a method 1600 of operating a gas turbine engine is illustrated in accordance with embodiments of the present subject matter. In general, the method 1600 will be described herein with reference to the gas turbine engine 100, the ACC system 101, the engine controller 210, and the control logic 350 described above with reference to FIGS. 1-13. However, it will be appreciated by those of ordinary skill in the art that the disclosed method 1600 may generally be utilized with any suitable turbomachine and/or may be utilized in connection with a system having any other suitable system configuration. In addition, although FIG. 14 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As discussed above, the gas turbine engine of the method 1600 may include a first component and a second component rotatable relative to the first component. A clearance may be defined between the first component and the second component. The gas turbine engine may further include a clearance adjustment system having a piezoelectric actuator coupled to the first component. The piezoelectric actuator may be configured to adjust the clearance.

The method include, at (1602) receiving sensor data from one or more sensors. The one or more sensors may be configured to sense data indicative of one or more parameters associated with a fan section of the gas turbine engine (e.g., rotational speed, acceleration, torque on the rotor shaft driving the fan, etc.). In various embodiments, the one or more sensors may include a sensor configured to sense data indicative of a compressor of the gas turbine engine (such as a pressure or a temperature within the HP compressor, and/or a pressure or temperature within the LP compressor 114 etc.). In some embodiments, the one or more sensors may include a sensor configured to sense data indicative of one or combustion section parameters (such as a temperature within the combustion section, a fuel flow to the combustion section, one or more pressures within or around the combustion section, etc.). In many embodiments, the one or more sensors may include a sensor configured to sense data indicative of one or more turbine section parameters (such as turbine inlet temperature, a rotational speed of the HP and/or LP turbines). In certain embodiments, the one or more sensors may include a sensor operable to sense data indicative of one or more parameters associated with the thrust bearings, such as but not limited to, rotor thrust and/or bearing vibration (for example, non-synchronous vibration and/or Alford whirl induced non-synchronous vibration). In some embodiments, the one or more sensors may include a sensor configured to sense data associated with the first component and/or the second component, such as data associated shroud segments and/or the rotor blades. In such embodiments, the sensor may be operable to sense data indicative of a blade tip clearance between rotor blades and shroud segments, or such as data indicative of a contact force when the shroud segments contact the blade tips of the rotor blades, or other data.

In exemplary embodiments, the method 1600 may include at (1604) receiving additional data associated with an engine event. The additional data may be additional sensor data and/or vehicle data. The vehicle data may include sensed and/or calculated values associated with vehicle to which the gas turbine engine is mounted. For instance, in embodiments where the vehicle to which the gas turbine engine is mounted is an aerial vehicle (i.e., an aircraft), the vehicle data can include a throttle position, a stick position, and/or X,Y,Z aircraft loads. The additional sensor data and/or the vehicle data received may be indicative or associated with an engine event. which may include one or more of the following: a cold clearance zeroing event 1614, a vehicle maneuver 1616, an engine acceleration event 1620, a stall event 1618, a bowed rotor start event 1622, a non-synchronous vibration (NSV) event 1624 (such as an Alford whirl NSV event), and/or a high rotor thrust event 1626.

The method 1600 may further include at (1606) generating a current clearance based on at least one of the sensor data and the additional data associated with the engine event. The current clearance may be a measured, calculated, and/or sensed value representative of the clearance between the first component and the second component. Particularly, the current clearance may be a measured, calculated, and/or sensed value representative of the radial clearance between blade tips and the shroud segments. In some implementations, the current clearance may be an average clearance value for the entire circumference of the gas turbine engine in the particular instance in time (e.g., an average of the radial clearances between each shroud segment and a respective blade tip about the entire circumferential direction). Alternatively, in other implementations, the current clearance may include an average radial clearance value for each shroud segment (e.g., a radial distance between the innermost surface of each shroud segment and the nearest blade tip).

In exemplary implementations, the method 1600 may include at (1608) generating a target clearance based on at least one of the sensor data and the additional data associated with the engine event. The target clearance may be a computed value that corresponds with an ideal clearance based on the present operating conditions of the gas turbine engine. For example, the target clearance may be the clearance corresponding with maximum efficiency and/or performance of the gas turbine engine for a given set of operating conditions (e.g., the target clearance may be different based on different operating conditions).

In many implementations, the method 1600 may include at (1610) comparing the target clearance to the current clearance. Additionally, the method 1600 may include at (1612) causing the clearance adjustment system to adjust the clearance based on the comparison between the target clearance and the actual clearance by actuating the piezoelectric actuator. The shroud segments may be actuated in one or more of the radial direction, the axial direction, and/or the circumferential direction to adjust the clearance between the shroud segments and the blade tips.

The current clearance and the average target clearance may be compared for each of the shroud segments to determine whether a clearance adjustment is necessary. Particularly, comparing at (1612) may include determining whether the current clearance is within a predetermined margin of the target clearance for each of the shroud segments. The predetermined margin may be a +15% margin of the target clearance, or such as a +10% margin of the target clearance, or such as a +5% margin of the target clearance, or such as a +1% margin of the target clearance.

The current clearance for a particular shroud segment is within the predetermined margin of the target clearance when the current clearance neither exceeds a maximum margin threshold nor falls below a minimum margin threshold. Likewise, the current clearance for a particular shroud segment is outside the predetermined margin when the average current clearance either exceeds the maximum margin threshold or falls below a minimum margin threshold.

When the current clearance is outside of the predetermined margin of the target clearance (e.g., either exceeds the maximum margin threshold or falls below a minimum margin threshold), then the method may include adjusting (e.g., extending or retracting) the piezoelectric actuators to adjust the clearance. Particularly, if the current clearance exceeds the maximum margin threshold of the predetermined margin of the target clearance, then the clearance rate may be reduced by extending the piezoelectric actuators. By contrast, if the current clearance falls below the minimum margin threshold of the predetermined margin of the average target clearance, then the clearance rate may be increased by retracting the piezoelectric actuators. The control module may maintain the average current clearance within +5% of the average target clearance. For example, if the average current clearance exceeds +5% of the average target clearance, then the control module may generate a control signal that adjusts (e.g., increases or decreases) the piezoelectric actuators, which adjusts the clearance CL back to within +5% of the average target clearance.

In various implementations, as shown in FIG. 14, the engine event may be a cold clearance zeroing event 1614. The cold clearance zeroing (or calibration) event may occur when the gas turbine engine is fully assembled and at ambient temperature and/or pressure. That is, the cold clearance calibration event may occur when the gas turbine engine is shut off (i.e., the combustion section is not being supplied with fuel and the HP and LP shafts are not rotating). The cold clearance (i.e., the clearance between each of the shroud segments and the corresponding blade tips when the gas turbine engine is not operating and at ambient temperatures and/or pressures) may be determined by executing the cold clearance zeroing event. In this way, the cold clearance model shown in FIG. 4 (which accounts for cold clearance in the gas turbine engine by using aggregated historical gas turbine data) may be eliminated because the actual cold clearance for the gas turbine engine may be determined by utilizing the piezoelectric actuators during the cold clearance zeroing event.

For example, the engine controller may cause the clearance adjustment system to actuate the piezoelectric actuators to move the shroud segments from a starting position to a contact position in which each of the shroud segments contact a blade tip. In such embodiments, one or more sensors may be operable to sense data indicative of a contact force between the shroud segments and the blade tips and provide the data to the engine controller, such that the engine controller can determine when the shroud segments are contacting the blade tips. In such embodiments, receiving the additional data at (1604) may include receiving the additional data as cold clearance data. The cold clearance data may include the data indicative of a contact force between the shroud segments and the blade tips. The cold clearance data may include an extension length of the piezoelectric actuators when the shroud segments are in contact with blade tips (e.g., how far the piezoelectric actuators had to extend from the starting position to get to the contact position). The engine controller may compare the starting position to the contact position to determine the cold clearance (e.g., the radial distance between the shroud segments and the blade tips 201 when the piezoelectric actuators are in the starting position). In exemplary implementations, the average current clearance may be at least partially based on the determined cold clearance data indicative of the cold clearance.

In some embodiments, as shown in FIG. 14, the engine event may be a vehicle maneuver 1616 (such as an aircraft maneuver). An aircraft maneuver refers to a deliberate change in the flight path or attitude of an aircraft.

In such embodiments, the method may include receiving vehicle data indicative of aa vehicle maneuver (e.g., that the gas turbine engine is preparing to engage in, or is in the process of executing, a vehicle maneuver). For example, the vehicle data may be indicative of a current stick position (which indicates the current yaw, pitch, and/or roll from the aircraft). The vehicle data may also include the current X, Y, Z aircraft loads. The current yaw, pitch, and/or roll and the current X, Y, Z aircraft loads may be received in order to determine whether the gas turbine engine is about to (or is in the process of) executing a vehicle maneuver.

The method may further include determining a predicted mechanical distortion of one or more components of the gas turbine engine based on the vehicle data indicative of a vehicle maneuver. That is, the engine controller may predict what the future X, Y, Z engine loads will be (e.g., forward in time) based on the current X, Y, Z engine loads and the current stick position. For example, if the pilot shifts the stick to make a turn, the engine controller may receive the adjustment to the stick position and the current X, Y, Z aircraft loads as the vehicle data, and the engine controller may predict what the engine loads will be when the aircraft is performing the turn. Based on the predicted future engine loads, the method may include generating the future engine deflection. The future engine deflection may include the predicted mechanical distortion of one or more engine components as a result of the vehicle maneuver. In such implementations, the method may include causing the clearance adjustment system to adjust the clearance by actuating the piezoelectric actuator based on the predicted future engine deflection and/or the predicted mechanical distortion of one or more engine components.

In this way, when the aircraft is about to perform a maneuver, the engine controller may determine the predicted mechanical distortions to one or more engine components that will occur during the maneuver, and the clearance between each shroud segment and the blade tips may be independently adjusted to account for the determined mechanical distortions that will occur during the maneuver to prevent a rub and/or pinch event.

Instead of, or in addition to, calculating the predicted (e.g., forward in time) mechanical distortions prior to executing a vehicle maneuver and adjusting the clearance, the method may include determining a current (e.g., real time) mechanical distortion while executing a vehicle maneuver adjusting the clearance. In such embodiments, the method may include receiving vehicle data indicative that the gas turbine engine is engaged in a vehicle maneuver. For example, For the engine controller may receive the current stick position (i.e., the current yaw, pitch, and/or roll from the aircraft) and the current X, Y, Z aircraft loads as vehicle data. The engine controller may utilize this vehicle data to calculate the current engine load. For example, if the pilot adjust the position of stick to make a turn, once the vehicle (e.g., an aircraft) begins making the turn, the engine controller may determine what the engine loads are as the aircraft is performing the turn at least partially based on the vehicle data indicative that the gas turbine engine is engaged in a vehicle maneuver. Based on the determined current engine loads, the method may include calculating the current engine deflections, such as the mechanical deflection of the rotor, the rotor blades, the shroud segments, the casing, or other components in the turbine caused by performance of the aircraft maneuver. In such implementations, the method may include generating the current clearance at least partially based on the current mechanical distortion, which may thereby cause the clearance adjustment system to adjust the clearance by actuating the piezoelectric actuator based on the current engine deflections.

Additionally, the engine controller may include a local thermal distortion table, and the current clearance may be determined at least partially based on the local thermal distortion table. The local thermal distortion table may include thermal distortion characteristics of the specific components in the turbine, such as the rotor, the rotor blades, the shroud segments, the casing, or others.

In this way, when the aircraft is performing maneuvers, the engine controller may determine the current mechanical distortions and/or deflections that are occurring in one or more components of the gas turbine engine during the maneuver, and the clearance between each shroud segment and the blade tips may be independently adjusted (e.g., by actuating the piezoelectric actuators) to account for the current mechanical distortions and/or deflections.

In various implementations, as shown in FIG. 14, the engine event may be a stall event. In such implementations, the method may include determining that the additional data is indicative of a stall event. The method may further include determining a clearance required to clear the stall event. For example, once it is determined that a stall event is occurring (at least partially based on the sensor data and/or vehicle data), and the clearance required to clear the stall event is determined, the method may include generating the target clearance at least partially based on the clearance required to clear the stall event. That is, the average target clearance may be modified and/or calculated at least partially based on the determined clearance required to clear the stall event.

The clearance may then be adjusted by actuating the piezoelectric actuators until the rotating stall has been cleared and the stall event has ended. For example, in response to sensing data indicative of conditions within a predetermined range of a compressor and/or turbine stall (i.e., a stall event), the engine controller may adjust (e.g., increase or decrease) the clearance between the blade tips and the shroud segments by actuating the piezoelectric actuators until the stall event has been cleared.

In some implementations, the engine event may be an engine acceleration event 1620. In such implementations, the method may include receiving, as the additional data, acceleration data indicative that the gas turbine engine is engaged in an engine acceleration event. The method may further include determining a predicted mechanical expansion of the second component that occurs as a result of the engine acceleration event. For example, the rotational components, such as the rotor and the rotor blades, may mechanically expand as a result of the acceleration event (e.g., the engine increasing rotational speed of the shafts). The method may further include determining an acceleration clearance required to prevent a rub event based on the determined mechanical expansion of the second component. As a result, the method may further include generating the target clearance at least partially based on the acceleration clearance.

In many implementations, the engine event may be a bowed rotor start event 1622. The bowed rotor start event may be when the gas turbine engine is shut off and a rotor of the gas turbine engine is in a bowed condition. In such implementations, the method may include determining that the additional data is indicative of a bowed rotor and/or a bowed rotor start event. Once the bowed rotor and/or bowed rotor start event are determined, the method may further include determining a maximum available clearance. That is, the method may include determining how much the stator segments can be retracted by actuating the piezoelectric actuators while still being extended enough to start the gas turbine engine (e.g., too much fluid isn't flowing over the rotor blades, but rather through them).

The method may include determining whether the maximum clearance is large enough to clear the bowed condition. That is, the method may include determining whether the maximum available clearance large enough to allow the rotor in a bowed rotor condition to rotate without causing rub/pinch between the rotor blades and the shroud segments (i.e., the maximum clearance exceeds the required clearance).

If enough clearance is available to clear the bowed rotor condition (e.g., the maximum available clearance is larger than the required clearance), the method may include causing the clearance adjustment system to adjust the clearance and start the gas turbine engine. The clearance adjustment system may adjust the clearance to be between about 0.1% and about 20% larger than the required clearance, or such as between about 0.1% and about 15% larger than the required clearance, or such as between about 0.1% and about 10% larger than the required clearance, or such as between about 0.1% and about 5% larger than the required clearance while still being less than the maximum available clearance. Subsequently, or simultaneously, the method may include starting the turbine engine (e.g., by supplying fuel to the combustion section, igniting the fuel, and providing the combustion gases to the turbine section to rotate the rotor and produce thrust).

If enough clearance is not available to clear the bowed rotor condition (e.g., the maximum available clearance is smaller than the required clearance), the method may include rotating the rotor with an electric motor while keeping the gas turbine engine shut off. That is, the method may include operating an electric motor to rotate the rotor in the bowed condition until enough clearance is available to clear the bowed rotor condition (e.g., the maximum available clearance is smaller than the required clearance).

In some implementations, the engine event may be a non-synchronous vibration (NSV) event 1624. In such implementations, the method may include determining that the additional data is indicative of non-synchronous vibration in the gas turbine engine (such as in the thrust bearings of the gas turbine engine). In response, the method may include adjusting, with the clearance adjustment system, the clearance over a time period to clear the NSV event.

In some implementations, the NSV event 1624 may be caused by Alford whirl in thrust bearings (i.e., Alford whirl induced NSV). In such scenarios, the method may include determining that the additional data is indicative of Alford whirl induced NSV in the thrust bearings of the gas turbine engine. Subsequently, the method may include identifying a circumferential location of minimum clearance between at least one shroud segment of the plurality of shroud segments and the blade tips of the rotor blades. Subsequently, the method may include adjusting, with the clearance adjustment system, a position of the at least one shroud segments corresponding with the circumferential location of minimum clearance.

In various implementation, the engine event may be a high rotor thrust event 1626. In such implementations, the method may include determining that the additional data is indicative of rotor thrust in the gas turbine engine that exceeds a predetermined rotor thrust threshold. In response, the method may include generating the target clearance that reduces rotor thrust at least partially based on determining that the additional data is indicative of rotor thrust in the gas turbine engine that exceeds the predetermined rotor thrust threshold. Finally, the method may include causing the clearance adjustment system to adjust the clearance by actuating the piezoelectric actuators.

The ACC system disclosed herein uses piezoelectric actuator(s) that provide fast response clearance control without the thermal delay seen in the conventional ACC system. Additionally, the ACC system disclosed herein maintains desired clearances between the blade tip and shroud segments without additional margin for various operating conditions, which will lead to performance improvement and provide better exhaust gas temperature (EGT) control capability. In certain examples, piezoelectric material generates linear displacement when an electric field is applied. The linear displacement can have a force, and examples disclosed herein apply the linear force of the piezoelectric material for the ACC system to achieve fast response clearance control. This advantageously allows the ACC system to maintain tight clearances (e.g., within +5% of target clearance) during various engine events while preventing a pinch/rub event between the rotating component and the stationary component.

Further aspects are provided by the subject matter of the following clauses:

A method of operating a gas turbine engine, the gas turbine engine including a first component and a second component rotatable relative to the first component, a clearance being defined between the first component and the second component, the gas turbine engine further comprising a clearance adjustment system having a piezoelectric actuator coupled to the first component and configured to adjust the clearance, the method comprising: receiving sensor data from one or more sensors; receiving additional data associated with an engine event; generating a current clearance based on at least one of the sensor data and the additional data associated with the engine event; generating a target clearance based on at least one of the sensor data and the additional data associated with the engine event; comparing the target clearance to the current clearance; and causing the clearance adjustment system to adjust the clearance based on the comparison between the target clearance and the actual clearance by actuating the piezoelectric actuator.

The method of any preceding clause, wherein the engine event is a cold clearance zeroing event, and wherein the method further comprises: causing the clearance adjustment system to actuate the piezoelectric actuator such that the first component contacts the second component; receiving the additional data as cold clearance data; and generating the current clearance at least partially based on the cold clearance data.

The method of any preceding clause, wherein the engine event is a vehicle maneuver, and wherein further comprises: receiving vehicle data indicative of a vehicle maneuver of the gas turbine engine; determining a predicted distortion of one or more components of the gas turbine engine based on the vehicle data indicative of the vehicle maneuver; and generating the target clearance at least partially based on the predicted distortion.

The method of any preceding clause, wherein the engine event is a vehicle maneuver, and wherein the method further comprises: receiving vehicle data indicative that the gas turbine engine is engaged in a vehicle maneuver; determining a current distortion of one or more components of the gas turbine engine based on the vehicle data indicative that the gas turbine engine is engaged in a vehicle maneuver; and generating the current clearance at least partially based on the current distortion.

The method of any preceding clause, wherein the engine event is an engine acceleration event, and wherein the method further comprises: receiving acceleration data indicative that the gas turbine engine is engaged in an engine acceleration event; determining a predicted mechanical deflection of the second component that occurs as a result of the engine acceleration event; determining an acceleration clearance required to prevent a rub event based on the determined mechanical expansion of the second component; and generating the target clearance at least partially based on the acceleration clearance.

The method of any preceding clause, wherein the engine event is a stall event, and wherein the method further comprises: determining that the additional data is indicative of a stall event; determining a clearance required to clear the stall event; and generating the target clearance at least partially based on the clearance required to clear the stall event.

The method of any preceding clause, wherein the engine event is a bowed rotor start event in which the gas turbine engine is shut off and a rotor of the gas turbine engine is in a bowed condition, and wherein the method further comprises: determining that the additional data is indicative of a bowed rotor; determining a maximum available clearance; determining whether the maximum clearance is large enough to clear the bowed condition; and performing one of the following control actions: causing the clearance adjustment system to adjust the clearance and starting the gas turbine engine when the maximum available clearance is large enough to clear the bowed condition; or rotating the rotor with an electric motor while keeping the gas turbine engine shut off when the maximum available clearance is not large enough to clear the bowed condition.

The method of any preceding clause, wherein the engine event is a non-synchronous vibration event, and wherein the method further comprises: determining that the additional data is indicative of non-synchronous vibration in the gas turbine engine; and adjusting, with the clearance adjustment system, the clearance over a time period to clear the non-synchronous vibration event.

The method of any preceding clause, wherein the first component is a plurality of shroud segments each coupled a respective piezoelectric actuator, wherein the second component is a plurality of rotor blades each extending from a rotor to a blade tip, wherein a respective clearance is defined between each shroud segment of the plurality of shroud segments and a rotor blade of the plurality of rotor blades, wherein the engine event is a non-synchronous vibration event, and wherein the method further comprises: determining that the additional data is indicative of non-synchronous vibration in the gas turbine engine; and identifying a circumferential location of minimum clearance between at least one shroud segment of the plurality of shroud segments and the blade tips of the rotor blades; and adjusting, with the clearance adjustment system, a position of the at least one shroud segments corresponding with the circumferential location of minimum clearance.

The method of any preceding clause, wherein the engine event is a high rotor thrust event, and wherein the method further comprises: determining that the additional data is indicative of rotor thrust in the gas turbine engine exceeds a predetermined rotor thrust threshold; and generating the target clearance that reduces rotor thrust at least partially based on determining that the additional data is indicative of rotor thrust in the gas turbine engine that exceeds the predetermined rotor thrust threshold.

A gas turbine engine, comprising: a first component; a second component rotatable relative to the first component, a clearance being defined between the first component and the second component; a clearance adjustment system having a piezoelectric actuator coupled to the first component and configured to adjust the clearance according to a clearance control scheme; and an engine controller in operable communication with the clearance adjustment system, the engine controller having one or more processors configured to implement the clearance control scheme, in implementing the clearance control scheme, the one or more processors are configured to: receive sensor data from one or more sensors; receive additional data associated with an engine event; generate a current clearance based on at least one of the sensor data and the additional data associated with the engine event; generate a target clearance based on at least one of the sensor data and the additional data associated with the engine event; compare the target clearance to the current clearance; and cause the clearance adjustment system to adjust the clearance based on the comparison by actuating the piezoelectric actuator.

The gas turbine engine of any preceding clause, wherein the engine event is a cold clearance zeroing event, and wherein during the cold clearance zeroing event the one or more processors are further configured to: cause the clearance adjustment system to actuate the piezoelectric actuator such that the first component contacts the second component; receive the additional data as cold clearance data; and generate the current clearance at least partially based on the cold clearance data.

The gas turbine engine of any preceding clause, wherein the engine event is a vehicle maneuver, and wherein the one or more processors are further configured to: receive vehicle data indicative of a vehicle maneuver of the gas turbine engine; determine a predicted distortion of one or more components of the gas turbine engine based on the vehicle data indicative of the vehicle maneuver; generate the target clearance at least partially based on the predicted distortion.

The gas turbine engine of any preceding clause, wherein the engine event is a vehicle maneuver, and wherein during the vehicle maneuver the one or more processors are further configured to: receive vehicle data indicative that the gas turbine engine is engaged in a vehicle maneuver; determine a current distortion of one or more components of the gas turbine engine based on the vehicle data indicative that the gas turbine engine is engaged in a vehicle maneuver; generate the current clearance at least partially based on the current distortion.

The gas turbine of any preceding clause, wherein the engine event is an engine acceleration event, and wherein during the engine acceleration event the one or more processors are further configured to: receive acceleration data indicative that the gas turbine engine is engaged in an engine acceleration event; determine a predicted mechanical deflection of the second component that occurs as a result of the engine acceleration event; determine an acceleration clearance required to prevent a rub event based on the determined mechanical expansion of the second component; and generate the target clearance at least partially based on the acceleration clearance.

The gas turbine of any preceding clause, wherein the engine event is a stall event, and wherein the one or more processors are further configured to: determine that the additional data is indicative of a stall event; determine a clearance required to clear the stall event; and generate the target clearance at least partially based on the clearance required to clear the stall event.

The gas turbine of any preceding clause, wherein the engine event is a bowed rotor start event in which the gas turbine engine is shut off and a rotor of the gas turbine engine is in a bowed condition, and wherein the one or more processors are further configured to: determine that the additional data is indicative of a bowed rotor; determine a maximum available clearance; determine whether the maximum clearance is large enough to clear the bowed condition; and perform one of the following control actions: cause the clearance adjustment system to adjust the clearance and start the gas turbine engine when the maximum available clearance is large enough to clear the bowed condition; or rotate the bowed rotor with an electric motor while keeping the gas turbine engine shut off when the maximum available clearance is not large enough to clear the bowed condition.

The gas turbine of any preceding clause, wherein the engine event is a non-synchronous vibration event, and wherein the one or more processors are further configured to: determine that the additional data is indicative of non-synchronous vibration in the gas turbine engine; and adjust, with the clearance adjustment system, the clearance over a time period to clear the non-synchronous vibration event.

The gas turbine of any preceding clause, wherein the first component is a plurality of shroud segments each coupled a respective piezoelectric actuator, wherein the second component is a plurality of rotor blades each extending from a rotor to a blade tip, wherein a respective clearance is defined between each shroud segment of the plurality of shroud segments and a rotor blade of the plurality of rotor blades, wherein the engine event is a non-synchronous vibration event, and wherein the one or more processors are further configured to: determine that the additional data is indicative of non-synchronous vibration in the gas turbine engine; and identify a circumferential location of minimum clearance between at least one shroud segment of the plurality of shroud segments and the blade tips of the rotor blades; and adjust, with the clearance adjustment system, a position of the at least one shroud segments corresponding with the circumferential location of minimum clearance.

The gas turbine of any preceding clause, wherein the engine event is a high rotor thrust event, and wherein the one or more processors are further configured to: determine that the additional data is indicative of rotor thrust in the gas turbine engine that exceeds a predetermined rotor thrust threshold; and generate the target clearance that reduces rotor thrust at least partially based on determining that the additional data is indicative of rotor thrust in the gas turbine engine that exceeds a predetermined rotor thrust threshold.

A gas turbine engine, comprising: a first component; a second component rotatable relative to the first component, a clearance being defined between the first component and the second component; a clearance adjustment system having a piezoelectric actuator coupled to the first component and configured to adjust the clearance according to a clearance control scheme; and an engine controller in operable communication with the clearance adjustment system, the engine controller having one or more processors configured to implement the clearance control scheme, in implementing the clearance control scheme, the one or more processors are configured to: receive sensor data from one or more sensors; receive additional data associated with an engine event, wherein the engine event is one of an engine acceleration event or a vehicle maneuver; generate a current clearance based on at least one of the sensor data and the additional data associated with the engine event; generate a target clearance based on at least one of the sensor data and the additional data associated with the engine event; compare the target clearance to the current clearance; and cause the clearance adjustment system to adjust the clearance based on the comparison by actuating the piezoelectric actuator.

The gas turbine engine of any preceding clause, wherein the engine event is a vehicle maneuver, and wherein the one or more processors are further configured to: receive vehicle data indicative of a vehicle maneuver of the gas turbine engine; determine a predicted distortion of one or more components of the gas turbine engine based on the vehicle data indicative of the vehicle maneuver; generate the target clearance at least partially based on the predicted distortion.

The gas turbine engine of any preceding clause, wherein the engine event is a vehicle maneuver, and wherein during the vehicle maneuver the one or more processors are further configured to: receive vehicle data indicative that the gas turbine engine is engaged in a vehicle maneuver; determine a current distortion of one or more components of the gas turbine engine based on the vehicle data indicative that the gas turbine engine is engaged in a vehicle maneuver; generate the current clearance at least partially based on the current distortion.

The gas turbine engine of any preceding clause, wherein the engine event is a vehicle maneuver, wherein the one or more processors are further configured to: predict future X, Y, Z engine loads experienced as a result of the vehicle maneuver based on the current X, Y, Z engine loads and the current stick position; determine a predicted mechanical distortion of one or more engine components at least partially based on the future X, Y, Z engine loads; and generate the current clearance at least partially based on the determined predicted mechanical distortion.

The gas turbine engine of any preceding clause, wherein the engine event is a vehicle maneuver, and wherein the one or more processors are further configured to: receive vehicle data indicative of a vehicle maneuver of the gas turbine engine; and cause the clearance adjustment system to adjust the clearance at least one of before, during, and/or after the vehicle maneuver.

The gas turbine engine of any preceding clause, wherein the engine event is an engine acceleration event, and wherein during the engine acceleration event the one or more processors are further configured to: receive acceleration data indicative that the gas turbine engine is engaged in an engine acceleration event; determine a predicted mechanical deflection of the second component that occurs as a result of the engine acceleration event; determine an acceleration clearance required to prevent a rub event based on the determined predicted mechanical deflection of the second component; and generate the target clearance at least partially based on the acceleration clearance.

The gas turbine engine of any preceding clause, wherein the data indicative that the gas turbine engine is engaged in a vehicle maneuver includes a current stick position and a current X, Y, Z aircraft loads.

The gas turbine engine of any preceding clause, wherein the acceleration data indicative that the gas turbine is engaged in an engine acceleration event includes data indicative of a change in power demand.

An engine controller in operable communication with a clearance adjustment system of a gas turbine engine, the gas turbine engine having a first component and a second component rotatable relative to the first component, wherein a clearance is defined between the first component and the second component, the clearance adjustment system having a piezoelectric actuator coupled to the first component and configured to adjust the clearance according to a clearance control scheme, the engine controller comprising one or more processors configured to implement the clearance control scheme, in implementing the clearance control scheme, the one or more processors are configured to: receive sensor data from one or more sensors; receive additional data associated with an engine event; generate a current clearance based on at least one of the sensor data and the additional data associated with the engine event; generate a target clearance based on at least one of the sensor data and the additional data associated with the engine event; compare the target clearance to the current clearance; and cause the clearance adjustment system to adjust the clearance based on the comparison by actuating the piezoelectric actuator.

The engine controller of any preceding clause, wherein the engine event is a cold clearance zeroing event, and wherein during the cold clearance zeroing event the one or more processors are further configured to: cause the clearance adjustment system to actuate the piezoelectric actuator such that the first component contacts the second component; receive the additional data as cold clearance data; and generate the current clearance at least partially based on the cold clearance data.

The engine controller of any preceding clause, wherein the engine event is a vehicle maneuver, and wherein the one or more processors are further configured to: receive vehicle data indicative of a vehicle maneuver of the gas turbine engine; determine a predicted distortion of one or more components of the gas turbine engine based on the vehicle data indicative of the vehicle maneuver; generate the target clearance at least partially based on the predicted distortion.

The engine controller of any preceding clause, wherein the engine event is a vehicle maneuver, and wherein during the vehicle maneuver the one or more processors are further configured to: receive vehicle data indicative that the gas turbine engine is engaged in a vehicle maneuver; determine a current distortion of one or more components of the gas turbine engine based on the vehicle data indicative that the gas turbine engine is engaged in a vehicle maneuver; generate the current clearance at least partially based on the current distortion.

The engine controller of any preceding clause, wherein the data indicative that the gas turbine engine is engaged in a vehicle maneuver includes a current stick position and a current X. Y, Z engine loads.

The engine controller of any preceding clause, wherein the engine event is a vehicle maneuver, wherein the one or more processors are further configured to: predict future X, Y, Z engine loads experienced as a result of the vehicle maneuver based on the current X, Y, Z engine loads and the current stick position; determine a predicted mechanical distortion of one or more engine components at least partially based on the future X, Y, Z engine loads; and generate the current clearance at least partially based on the determined predicted mechanical distortion.

The engine controller of any preceding clause, wherein the engine event is a vehicle maneuver, and wherein the one or more processors are further configured to: receive vehicle data indicative of a vehicle maneuver of the gas turbine engine; and cause the clearance adjustment system to adjust the clearance at least one of before, during, and/or after the vehicle maneuver.

The engine controller of any preceding clause, wherein the engine event is an engine acceleration event, and wherein during the engine acceleration event the one or more processors are further configured to: receive acceleration data indicative that the gas turbine engine is engaged in an engine acceleration event; determine a predicted mechanical deflection of the second component that occurs as a result of the engine acceleration event; determine an acceleration clearance required to prevent a rub event based on the determined mechanical expansion predicted mechanical deflection of the second component; and generate the target clearance at least partially based on the acceleration clearance.

The engine controller of any preceding clause, wherein the acceleration data indicative that the gas turbine is engaged in an engine acceleration event includes data indicative of a change in power demand.

The engine controller of any preceding clause, wherein the engine event is a stall event, and wherein the one or more processors are further configured to: determine that the additional data is indicative of a stall event; determine a clearance required to clear the stall event; and generate the target clearance at least partially based on the clearance required to clear the stall event.

The engine controller of any preceding clause, wherein the engine event is a bowed rotor start event in which the gas turbine engine is shut off and a rotor of the gas turbine engine is in a bowed condition, and wherein the one or more processors are further configured to: determine that the additional data is indicative of a bowed rotor; determine a maximum available clearance; determine whether the maximum clearance is large enough to clear the bowed condition; and perform one of the following control actions: cause the clearance adjustment system to adjust the clearance and start the gas turbine engine when the maximum available clearance is large enough to clear the bowed condition; or rotate the bowed rotor with an electric motor while keeping the gas turbine engine shut off when the maximum available clearance is not large enough to clear the bowed condition.

The engine controller of any preceding clause, wherein the engine event is a non-synchronous vibration event, and wherein the one or more processors are further configured to: determine that the additional data is indicative of non-synchronous vibration in the gas turbine engine; and adjust, with the clearance adjustment system, the clearance over a time period to clear the non-synchronous vibration event.

The engine controller of any preceding clause, wherein the first component is a plurality of shroud segments each coupled a respective piezoelectric actuator, wherein the second component is a plurality of rotor blades each extending from a rotor to a blade tip, wherein a respective clearance is defined between each shroud segment of the plurality of shroud segments and a rotor blade of the plurality of rotor blades, wherein the engine event is a non-synchronous vibration event, and wherein the one or more processors are further configured to: determine that the additional data is indicative of non-synchronous vibration in the gas turbine engine; and identify a circumferential location of minimum clearance between at least one shroud segment of the plurality of shroud segments and the blade tips of the rotor blades; and adjust, with the clearance adjustment system, a position of the at least one shroud segments corresponding with the circumferential location of minimum clearance.

The gas turbine engine of any preceding clause, wherein the engine event is a high rotor thrust event, and wherein the one or more processors are further configured to: determine that the additional data is indicative of rotor thrust in the gas turbine engine that exceeds a predetermined rotor thrust threshold; and generate the target clearance that reduces rotor thrust at least partially based on determining that the additional data is indicative of rotor thrust in the gas turbine engine that exceeds a predetermined rotor thrust threshold.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine, comprising:
a shroud segment;
a rotor blade rotatable relative to the first component, a clearance being defined directly between the shroud segment and the rotor blade;
a clearance adjustment system having a piezoelectric actuator coupled to the shroud segment and configured to adjust the clearance according to a clearance control scheme; and
an engine controller in operable communication with the clearance adjustment system, the engine controller having one or more processors configured to implement the clearance control scheme, in implementing the clearance control scheme, the one or more processors are configured to:
receive sensor data from one or more sensors;
receive additional data associated with an engine event;
generate a current clearance based on at least one of the sensor data and the additional data associated with the engine event;
generate a target clearance based on at least one of the sensor data and the additional data associated with the engine event;
compare the target clearance to the current clearance; and
cause the clearance adjustment system to adjust the clearance based on the comparison by actuating the piezoelectric actuator.

2. The gas turbine engine of claim 1, wherein the engine event is a cold clearance zeroing event, and wherein during the cold clearance zeroing event the one or more processors are further configured to:
cause the clearance adjustment system to actuate the piezoelectric actuator such that the shroud segment contacts the rotor blade;
receive the additional data as cold clearance data; and
generate the current clearance at least partially based on the cold clearance data.

3. The gas turbine engine of claim 1, wherein the engine event is a vehicle maneuver, and wherein the one or more processors are further configured to:
receive vehicle data indicative of a vehicle maneuver of the gas turbine engine;
determine a predicted distortion of one or more components of the gas turbine engine based on the vehicle data indicative of the vehicle maneuver;
generate the target clearance at least partially based on the predicted distortion.

4. The gas turbine engine of claim 1, wherein the engine event is a vehicle maneuver, and wherein during the vehicle maneuver the one or more processors are further configured to:
receive vehicle data indicative that the gas turbine engine is engaged in a vehicle maneuver;
determine a current distortion of one or more components of the gas turbine engine based on the vehicle data indicative that the gas turbine engine is engaged in a vehicle maneuver;
generate the current clearance at least partially based on the current distortion.

5. The gas turbine engine of claim 4, wherein the data indicative that the gas turbine engine is engaged in a vehicle maneuver includes a current stick position and a current X, Y, Z engine loads.

6. The gas turbine engine of claim 1, wherein the engine event is a vehicle maneuver, wherein the one or more processors are further configured to:
predict future X, Y, Z engine loads experienced as a result of the vehicle maneuver based on the current X, Y, Z engine loads and the current stick position;
determine a predicted mechanical distortion of one or more engine components at least partially based on the future X, Y, Z engine loads; and
generate the current clearance at least partially based on the determined predicted mechanical distortion.

7. The gas turbine engine of claim 1, wherein the engine event is a vehicle maneuver, and wherein the one or more processors are further configured to:
receive vehicle data indicative of a vehicle maneuver of the gas turbine engine; and
cause the clearance adjustment system to adjust the clearance at least one of before, during, and/or after the vehicle maneuver.

8. The gas turbine engine of claim 1, wherein the engine event is an engine acceleration event, and wherein during the engine acceleration event the one or more processors are further configured to:
receive acceleration data indicative that the gas turbine engine is engaged in an engine acceleration event;
determine a predicted mechanical deflection of the rotor blade that occurs as a result of the engine acceleration event;
determine an acceleration clearance required to prevent a rub event based on the determined predicted mechanical deflection of the rotor blade; and
generate the target clearance at least partially based on the acceleration clearance.

9. The gas turbine engine of claim 8, wherein the acceleration data indicative that the gas turbine is engaged in the engine acceleration event includes data indicative of a change in power demand.

10. The gas turbine engine of claim 1, wherein the engine event is a stall event, and wherein the one or more processors are further configured to:
determine that the additional data is indicative of a stall event;
determine a clearance required to clear the stall event; and
generate the target clearance at least partially based on the clearance required to clear the stall event.

11. The gas turbine engine of claim 1, wherein the engine event is a bowed rotor start event in which the gas turbine engine is shut off and a rotor of the gas turbine engine is in a bowed condition, and wherein the one or more processors are further configured to:
determine that the additional data is indicative of a bowed rotor;
determine a maximum available clearance;
determine whether the maximum clearance is large enough to clear the bowed condition; and
perform one of the following control actions:
cause the clearance adjustment system to adjust the clearance and start the gas turbine engine when the maximum available clearance is large enough to clear the bowed condition; or
rotate the bowed rotor with an electric motor while keeping the gas turbine engine shut off when the maximum available clearance is not large enough to clear the bowed condition.

12. The gas turbine engine of claim 1, wherein the engine event is a non-synchronous vibration event, and wherein the one or more processors are further configured to:
determine that the additional data is indicative of non-synchronous vibration in the gas turbine engine; and
adjust, with the clearance adjustment system, the clearance over a time period to clear the non-synchronous vibration event.

13. The gas turbine engine of claim 1, wherein a plurality of shroud segments is each coupled a respective piezoelectric actuator, wherein a plurality of rotor blades each extending from a rotor to a blade tip, wherein a respective clearance is defined between each shroud segment of the plurality of shroud segments and a rotor blade of the plurality of rotor blades, wherein the engine event is a non-synchronous vibration event, and wherein the one or more processors are further configured to:
determine that the additional data is indicative of non-synchronous vibration in the gas turbine engine; and
identify a circumferential location of minimum clearance between at least one shroud segment of the plurality of shroud segments and the blade tips of the rotor blades; and
adjust, with the clearance adjustment system, a position of the at least one shroud segments corresponding with the circumferential location of minimum clearance.

14. The gas turbine engine of claim 1, wherein the engine event is a high rotor thrust event, and wherein the one or more processors are further configured to:
determine that the additional data is indicative of rotor thrust in the gas turbine engine that exceeds a predetermined rotor thrust threshold; and
generate the target clearance that reduces rotor thrust at least partially based on determining that the additional data is indicative of rotor thrust in the gas turbine engine that exceeds a predetermined rotor thrust threshold.

15. A gas turbine engine, comprising:
a shroud segment;
a rotor blade rotatable relative to the first component, a clearance being defined directly between the shroud segment and the rotor blade;
a clearance adjustment system having a piezoelectric actuator coupled to the shroud segment and configured to adjust the clearance according to a clearance control scheme; and
an engine controller in operable communication with the clearance adjustment system, the engine controller having one or more processors configured to implement the clearance control scheme, in implementing the clearance control scheme, the one or more processors are configured to:
receive sensor data from one or more sensors;
receive additional data associated with an engine event, wherein the engine event is one of an engine acceleration event or a vehicle maneuver;
generate a current clearance based on at least one of the sensor data and the additional data associated with the engine event;
generate a target clearance based on at least one of the sensor data and the additional data associated with the engine event;
compare the target clearance to the current clearance; and
cause the clearance adjustment system to adjust the clearance based on the comparison by actuating the piezoelectric actuator.

16. The gas turbine engine of claim 15, wherein the engine event is a vehicle maneuver, and wherein the one or more processors are further configured to:
receive vehicle data indicative of a vehicle maneuver of the gas turbine engine;
determine a predicted distortion of one or more components of the gas turbine engine based on the vehicle data indicative of the vehicle maneuver;
generate the target clearance at least partially based on the predicted distortion.

17. The gas turbine engine of claim 15, wherein the engine event is a vehicle maneuver, and wherein during the vehicle maneuver the one or more processors are further configured to:
receive vehicle data indicative that the gas turbine engine is engaged in a vehicle maneuver;
determine a current distortion of one or more components of the gas turbine engine based on the vehicle data indicative that the gas turbine engine is engaged in a vehicle maneuver;
generate the current clearance at least partially based on the current distortion.

18. The gas turbine engine of claim 15, wherein the engine event is a vehicle maneuver, wherein the one or more processors are further configured to:
predict future X, Y, Z engine loads experienced as a result of the vehicle maneuver based on the current X, Y, Z engine loads and the current stick position;
determine a predicted mechanical distortion of one or more engine components at least partially based on the future X, Y, Z engine loads; and
generate the current clearance at least partially based on the determined predicted mechanical distortion.

19. (canceled)

20. The gas turbine engine of claim 15, wherein the engine event is an engine acceleration event, and wherein during the engine acceleration event the one or more processors are further configured to:
receive acceleration data indicative that the gas turbine engine is engaged in the engine acceleration event;
determine a predicted mechanical deflection of the rotor blade that occurs as a result of the engine acceleration event;
determine an acceleration clearance required to prevent a rub event based on the determined predicted mechanical deflection of the rotor blade; and
generate the target clearance at least partially based on the acceleration clearance.

21. The gas turbine engine of claim 1, wherein the piezoelectric actuator includes a multilayer stack of piezoelectric material disposed within a housing, and wherein the piezoelectric actuator is attached to the shroud segment via one or more hangers.
